(19) United States
(12) Patent Application Publication
(10) Pub. No.: US 2013/0119260 A1
(43) Pub. Date: May 16, 2013

(54) RADIOGRAPHIC IMAGING DEVICE

(71) Applicant: FUJIFILM CORPORATION, Tokyo (JP)

(72) Inventors: Haruyasu NAKATSUGAWA, Ashigarakami-gun (JP); Naoyuki NISHINOU, Ashigarakami-gun (JP); Yasunori OHTA, Ashigarakami-gun (JP)

(73) Assignee: FUJIFILM CORPORATION, Tokyo (JP)

(21) Appl. No.: 13/682,736

(22) Filed: Nov. 21, 2012

Related U.S. Application Data
(63) Continuation of application No. PCT/JP2011/062530, filed on May 31, 2011.

(30) Foreign Application Priority Data
May 31, 2010 (JP) 2010-125314

(51) Int. Cl. G01T 1/20

(52) U.S. Cl. CPC G01T 1/2006
USPC 250/366

(57) ABSTRACT

A radiographic imaging device has two radiation detectors 20 (20A and 20B) that capture radiographic images. Sets of image information representing the radiographic images captured by the radiation detectors 20A and 20B can be individually read out, and sensor portions 13 configuring at least one of the radiation detectors 20 are configured to include an organic photoelectric conversion material that generates an electric charge by receiving light. Because of this, the radiographic imaging device can capture a variety of radiographic images.

### CROSS-REFERENCE TO RELATED APPLICATIONS

This application is a continuation application of International Application No. PCT/JP/2011/062530, filed May 31, 2011, which is incorporated herein by reference. Further, this application claims priority from Japanese Patent Application No. 2010-125314, filed May 31, 2010, which is incorporated herein by reference.

### TECHNICAL FIELD

The present invention relates to a radiographic imaging device.

### BACKGROUND ART

In recent years, radiation detectors such as flat panel detectors (FPD), in which a radiation-sensitive layer is placed on a thin-film transistor (TFT) active matrix substrate and which can directly convert radiation such as X-rays into digital data, have been put into practical use. Radiographic imaging devices using these radiation detectors have the advantage that, compared to conventional radiographic imaging devices using X-ray film or imaging plates, images can be checked instantly, and fluoroscopy, which continuously captures radiographic images (captures moving images), can also be performed.

As this kind of radiation detector, a variety of types have been proposed. For example, there is the indirect conversion method, in which the radiation is first converted into light by a CsI:Tl, GOS (Gd202S:Tb), or other scintillator and then the light into which the radiation has been converted is converted into electric charges by sensor portions such as photodiodes and the electric charges are stored. The radiographic imaging device reads out, as electrical signals, the electric charges that have been stored in the radiation detector, uses amplifiers to amplify the electrical signals that have been read out, and uses analog-to-digital (A/D) conversion components to convert the electrical signals into digital data.

As a technology relating to this kind of radiation detector, in JP-A No. 2002-168806, there is disclosed a technology in which the radiation detector is placed in such a way that the radiation that has passed through the subject is made incident from the scintillator side, part of the side of the scintillator to which the radiation is applied is covered by a mask member comprising a material that is opaque to the radiation, and the degree of deterioration of the radiation detector is found by comparing the dark current that is output from the photodiodes in the region covered by the mask member and the dark current that is output from the photodiodes in the region not covered by the mask member.

Further, in JP-A No. 2009-32854, there is described a radiation detector in which the sensor portions are formed by an organic photoelectric conversion material.

### DISCLOSURE OF INVENTION

### Technical Problem

Incidentally, radiation may be applied to a radiation detector from the front side on which the scintillator is disposed (front side illumination) or from the substrate side (back side) (back side illumination).

In a case where the radiation detector is back-side illuminated, an image with high sharpness is obtained because the light emission of the scintillator is close to the substrate. However, sensitivity drops because absorption of the radiation occurs in the substrate when the radiation passes through the substrate.

In a case where the radiation detector is front-side illuminated, a drop in sensitivity does not occur because there is no absorption of the radiation by the substrate. However, the sharpness of the obtained image becomes lower because the thicker the scintillator becomes, the more the light emission by the scintillator is away from the substrate.

The present invention has been made in view of the above circumstances, and it is an object thereof to provide a radiographic imaging device that can capture a variety of radiographic images.

### Solution to Problem

In order to achieve this object, a first aspect of the invention is a radiographic imaging device comprising an imaging component that is disposed with plural sensor portions sensitive to light and has at least two imaging systems that capture radiographic images expressed by light generated in a light-emitting layer that generates light as a result of radiation being applied, with the imaging component being configured to be able to individually read out sets of image information representing the radiographic images captured by the imaging systems, and with the sensor portions configuring at least one of the imaging systems being configured to include an organic photoelectric conversion material that generates an electric charge as a result of receiving light.

According to the first aspect of the invention, plural sensor portions sensitive to light are disposed in the imaging component, and the imaging component has at least two imaging systems that capture radiographic images expressed by light generated in a light-emitting layer that generates light as a result of radiation being applied. The imaging component can individually read out sets of image information representing the radiographic images captured by the imaging systems.

Additionally, in the imaging component, the sensor portions configuring at least one of the imaging systems are configured to include an organic photoelectric conversion material that generates an electric charge by receiving light.

In this way, according to the first aspect of the invention, the imaging component has at least two imaging systems that capture radiographic images, and sets of image information representing the radiographic images captured by the imaging systems can be individually read out. The sensor portions configuring at least one of the imaging systems is configured to include an organic photoelectric conversion material that generates an electric charge by receiving light. By capturing radiographic images individually with the imaging systems and synthesizing the radiographic images captured by the imaging systems, a variety of radiographic images can be captured.

According to a second aspect of the invention, the radiographic imaging device may further comprise a read-out component that individually reads out the sets of image information representing the radiographic images captured by the imaging systems and an image processing component that performs image processing that performs addition or weighted addition of the sets of image information read out by the read-out component.

Further, according to a third aspect of the invention, the imaging component may be configured in such a way that the light-emitting layer and two substrates, in which are formed the plural sensor portions and plural switch elements for reading out the electric charges generated in the sensor portions, are layered.

Further, according to a fourth aspect of the invention, the substrates may be configured by any of plastic resin, aramids, bio-nanofibers, or flexible glass substrates.

Further, according to a fifth aspect of the invention, the switch elements may be thin-film transistors configured to include an amorphous oxide in their active layers.

Further, according to a sixth aspect of the invention, the imaging component may be configured such that two of the light-emitting layers are disposed, a light-blocking layer that blocks light is disposed, and the light-emitting layers and the substrates are layered on one side and the other side of the light-blocking layer.

Further, according to a seventh aspect of the invention, the two light-emitting layers may have different light emission characteristics with respect to radiation.

Further, according to an eighth aspect of the invention, a change to any of at least one of a thickness of the light-emitting layers, a particle diameter of particles that fill the light-emitting layers and emit light as a result of radiation being applied, a multilayer structure of the particles, a fill rate of the particles, a doping amount of an activator, a material of the light-emitting layers, or a layer structure of the light-emitting layers or a formation of a reflective layer that reflects the light on the sides of the light-emitting layers not opposing the substrates may be performed on the two light-emitting layers.

Further, according to a ninth aspect of the invention, one of the two light-emitting layers may have a light emission characteristic with an image quality emphasis, and the other of the two light-emitting layers may have a light emission characteristic with a sensitivity emphasis.

Further, according to a tenth aspect of the invention, the two light-emitting layers may have substantially identical light emission characteristics with respect to radiation when radiation has been applied from one side.

Further, according to an eleventh aspect of the invention, the two substrates may have different read-out characteristics of reading out signals obtained by reading out the stored electric charges.

Further, according to a twelfth aspect of the invention, the radiographic imaging device may further comprise: an imaging unit that is formed in the shape of a flat plate, has the imaging component built into it, and can capture radiographic images resulting from applied radiation in both one side and the other side of the flat plate; a control unit that has the read-out component and the image processing component built into it; and a coupling member that couples together the imaging unit and the control unit in such a way that the imaging unit and the control unit can be opened to a deployed state in which the imaging unit and the control unit lie side by side and closed to a stored state in which the imaging unit and the control unit are folded on top of each other.

Further, according to a thirteenth aspect of the invention, the radiographic imaging device may further comprise: an imaging unit that is formed in the shape of a flat plate, has the imaging component built into it, and can capture radiographic images resulting from applied radiation in both one side and the other side of the flat plate; a control unit that has the read-out component and the image processing component built into it; and a coupling member that couples together the imaging unit and the control unit in such a way that one side and the other side of the imaging unit can be reversed with respect to the control unit.

### Advantageous Effects of Invention

The radiographic imaging device of the present invention has the excellent effect that it can capture a variety of radiographic images.

### BRIEF DESCRIPTION OF DRAWINGS

FIG. 1 is a cross-sectional schematic view showing the schematic configuration of three pixel sections of a radiation detector pertaining to an embodiment;

FIG. 2 is a cross-sectional view schematically showing the configuration of a signal output portion of one pixel section of the radiation detector pertaining to the embodiment;

FIG. 3 is a plan view showing the configuration of the radiation detector pertaining to the embodiment;

FIG. 4 is a cross-sectional view showing the configuration of an imaging component pertaining to the embodiment;

FIG. 5 is a schematic view showing a multilayer structure of small particles and large particles in a scintillator;

FIG. 6 is a cross-sectional view showing a configuration in a case where a reflective layer is formed on the side of the scintillator on the opposite side of a TFT substrate;

FIG. 7 is a perspective view showing the configuration of an electronic cassette pertaining to the embodiment;

FIG. 8 is a cross-sectional view showing the configuration of the electronic cassette pertaining to the embodiment;

FIG. 9 is a block diagram showing the configurations of main portions of an electrical system of the electronic cassette pertaining to the embodiment;

FIG. 10 is a perspective view showing a layer configuration of two radiation detectors, two gate line drivers, and two signal processing components pertaining to the embodiment;

FIG. 11 is a flowchart showing a flow of processing of an image read-out processing program pertaining to the embodiment;

FIG. 12 is a cross-sectional view for describing front side illumination and back side illumination of the radiation detector with radiation X;

FIG. 13 is a cross-sectional view showing the configuration of an imaging component pertaining to another embodiment;

FIG. 14 is a cross-sectional view showing the configuration of an imaging component pertaining to another embodiment;

FIG. 15 is a cross-sectional view showing the configuration of an imaging component pertaining to another embodiment;

FIG. 16 is a cross-sectional view showing the configuration of an imaging component pertaining to another embodiment;

FIG. 17 is a cross-sectional view showing the configuration of an imaging component pertaining to another embodiment;

FIG. 18 is a cross-sectional view showing the configuration of an imaging component pertaining to another embodiment;

FIG. 19 is a cross-sectional view showing the configuration of an imaging component pertaining to another embodiment;

FIG. 20 is a perspective view showing a layer configuration of two radiation detectors, two gate line drivers, and two signal processing components pertaining to another embodiment;

FIG. 21 is a perspective view showing the configuration of an electronic cassette that can be opened and closed pertaining to another embodiment;

FIG. 22 is a perspective view showing the configuration of the electronic cassette that can be opened and closed pertaining to the other embodiment;

FIG. 23 is a cross-sectional view showing the configuration of the electronic cassette that can be opened and closed pertaining to the other embodiment;

FIG. 24 is a perspective view showing the configuration of an electronic cassette that can be reversed pertaining to another embodiment;

FIG. 25 is a perspective view showing the configuration of the electronic cassette that can be reversed pertaining to the other embodiment; and

FIG. 26 is a cross-sectional view showing the configuration of the electronic cassette that can be reversed pertaining to the other embodiment.

### BEST MODE FOR CARRYING OUT THE INVENTION

A mode for carrying out the present invention will be described below with reference to the drawings.

First, the configuration of an indirect conversion radiation detector 20 pertaining to the present embodiment will be initially described.

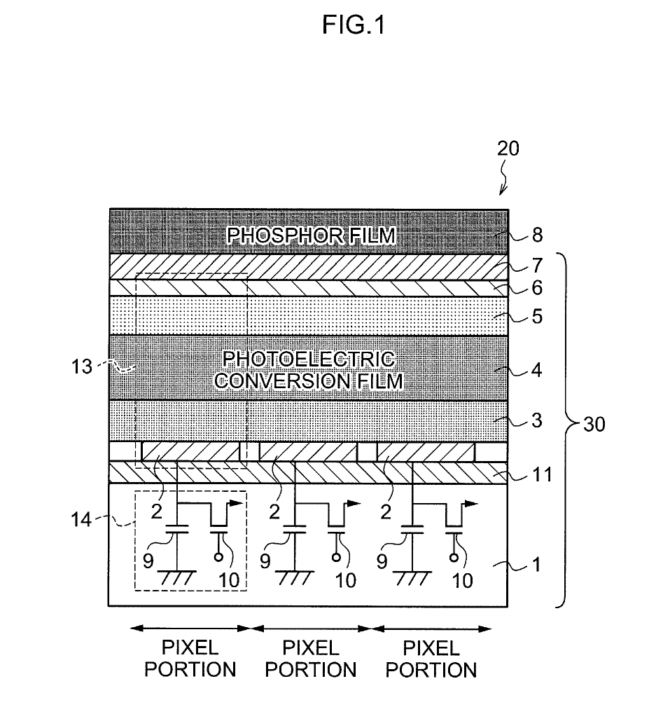

FIG. 1 is a cross-sectional schematic view schematically showing the configuration of three pixel sections of the radiation detector 20 that is an embodiment of the present invention.

In the radiation detector 20, signal output portions 14, sensor portions 13, and a scintillator 8 are sequentially layered on an insulating substrate 1. Pixel portions are configured by the signal output portions 14 and the sensor portions 13. The pixel portions are plurally arrayed on the substrate 1 and are configured in such a way that the signal output portion 14 and the sensor portion 13 in each pixel portion lie on top of each another.

The scintillator 8 is formed via a transparent insulating film 7 on the sensor portions 13 and comprises a phosphor film that converts radiation made incident thereon from above (the opposite side of the substrate 1) into light and emits light. By disposing the scintillator 8, the scintillator 8 absorbs the radiation that has passed through the subject and emits light.

It is preferred that the wavelength region of the light emitted by the scintillator 8 be in the visible light region (a wavelength of 360 nm to 830 nm), and it is more preferred that the wavelength region of the light emitted by the scintillator 8 include the green wavelength region to enable monochrome imaging by the radiation detector 20.

As the phosphor used in the scintillator 8, specifically a phosphor including cesium iodide (CsI) is preferred in the case of performing imaging using X-rays as the radiation, and using CsI(Tl) (cesium iodide to which thallium has been added) whose emission spectrum when X-rays are applied is 420 nm to 700 nm is particularly preferred. The emission peak wavelength of CsI(Tl) in the visible light range is 565 nm.

The sensor portions 13 have an upper electrode 6, lower electrodes 2, and a photoelectric conversion film 4 that is placed between the upper and lower electrodes. The photoelectric conversion film 4 is configured by an organic photoelectric conversion material that absorbs the light emitted by the scintillator 8 and generates an electric charge.

It is preferred that the upper electrode 6 be configured by a conducting material that is transparent at least with respect to the emission wavelength of the scintillator 8 because it is necessary that the upper electrode 6 allow the light produced by the scintillator 8 to be made incident on the photoelectric conversion film 4; specifically, using a transparent conducting oxide (TCO) whose transmittance with respect to visible light is high and whose resistance value is small is preferred. A metal thin film of Au or the like can also be used as the upper electrode 6, but its resistance value tends to increase when trying to obtain a transmittance of 90% or more, so a TCO is more preferred. For example, ITO, IZO, AZO, FTO, SnO₂, TiO₂, ZnO₂, etc. can be preferably used. ITO is most preferred from the standpoints of process ease, low resistance, and transparency. The upper electrode 6 may have a single configuration shared by all the pixel portions or may be divided per pixel portion.

The photoelectric conversion film 4 includes the organic photoelectric conversion material, absorbs the light emitted from the scintillator 8, and generates an electric charge corresponding to the absorbed light. The photoelectric conversion film 4 including the organic photoelectric conversion material in this way has a sharp absorption spectrum in the visible region and absorbs virtually no electromagnetic waves other than the light emitted by the scintillator 8. It can effectively suppress noise generated as a result of radiation such as X-rays being absorbed by the photoelectric conversion film 4.

It is preferred that the absorption peak wavelength of the organic photoelectric conversion material configuring the photoelectric conversion film 4 be as close as possible to the emission peak wavelength of the scintillator 8 so that the organic photoelectric conversion material most efficiently absorbs the light emitted by the scintillator 8. It is ideal that the absorption peak wavelength of the organic photoelectric conversion material and the emission peak wavelength of the scintillator 8 coincide, but as long as the difference between them is small, the organic photoelectric conversion material can sufficiently absorb the light emitted from the scintillator 8. Specifically, it is preferred that the difference between the absorption peak wavelength of the organic photoelectric conversion material and the emission peak wavelength of the scintillator 8 with respect to radiation be within 10 nm, and it is more preferred that the difference be within 5 nm.

Examples of organic photoelectric conversion materials that can satisfy this condition include quinacridone organic compounds and phthalocyanine organic compounds. For example, the absorption peak wavelength of quinacridone in the visible region is 560 nm, so if quinacridone is used as the organic photoelectric conversion material and CsI(Tl) is used as the material of the scintillator 8, it becomes possible to keep the difference between the peak wavelengths within 5 nm and the amount of electric charge generated in the photoelectric conversion film 4 can be substantially maximized.

Next, the photoelectric conversion film 4 that can be applied to the radiation detector 20 pertaining to the present embodiment will be specifically described.

The electromagnetic wave absorption/photoelectric conversion site in the radiation detector 20 pertaining to the present invention can be configured by the pair of electrodes 2 and 6 and an organic layer including the organic photoelectric conversion film 4 sandwiched between the electrodes 2 and 6. More specifically, the organic layer can be formed by layering or mixing together a site that absorbs electromagnetic waves, a photoelectric conversion site, an electron-transporting site, a hole-transporting site, an electron-blocking site, a hole-blocking site, a crystallization preventing site, electrodes, an interlayer contact improving site, etc.

It is preferred that the organic layer include an organic p-type compound or an organic n-type compound.

Organic p-type semiconductors (compounds) are donor organic semiconductors (compounds) represented mainly by hole-transporting organic compounds and refer to organic compounds having the property that they easily donate electrons. More specifically, organic p-type semiconductors (compounds) refer to organic compounds whose ionization potential is the smaller of the two when two organic materials are brought into contact with each other and used. Consequently, any organic compound can be used as the donor organic compound provided that it is an electron-donating organic compound.

Organic n-type semiconductors (compounds) are accepter organic semiconductors (compounds) represented mainly by electron-transporting organic compounds and refer to organic compounds having the property that they easily accept electrons. More specifically, organic n-type semiconductors (compounds) refer to organic compounds whose electron affinity is the greater of the two when two organic compounds are brought into contact with each other and used. Consequently, any organic compound can be used as the accepter organic compound provided that it is an electron-accepting organic compound.

Materials that can be applied as the organic p-type semiconductor and the organic n-type semiconductor, and the configuration of the photoelectric conversion film 4, are described in detail in JP-A No. 2009-32854, so description thereof will be omitted.

As for the thickness of the photoelectric conversion film 4, it is preferred that the film thickness be as large as possible for absorbing the light from the scintillator 8, but considering the proportion that does not contribute to electric charge separation, 30 nm to 300 nm is preferred, 50 nm to 250 nm is more preferred, and 80 nm to 200 nm is particularly preferred.

In the radiation detector 20 shown in FIG. 1, the photoelectric conversion film 4 has a single configuration shared by all the pixel portions, but it may also be divided per pixel portion.

The lower electrodes 2 are a thin film that has been divided per pixel portion. The lower electrodes 2 can be configured by a transparent or opaque conducting material, and aluminum, silver, etc. can be suitably used.

The thickness of the lower electrodes 2 can be 30 nm to 300 nm, for example.

In the sensor portions 13, one from among the electric charge (holes and electrons) generated in the photoelectric conversion film 4 can be moved to the upper electrode 6 and the other can be moved to the lower electrodes 2 by applying a predetermined bias voltage between the upper electrode 6 and the lower electrodes 2. In the radiation detector 20 of the present embodiment, a wire is connected to the upper electrode 6, and the bias voltage is applied to the upper electrode 6 via this wire. Further, the polarity of the bias voltage is decided in such a way that the electrons generated in the photoelectric conversion film 4 move to the upper electrode 6 and the holes move to the lower electrodes 2, but this polarity may also be the opposite.

It suffices for the sensor portions 13 configuring each of the pixel portions to include at least the lower electrodes 2, the photoelectric conversion film 4, and the upper electrode 6, but to suppress an increase in dark current, disposing at least either of an electron-blocking film 3 and a hole-blocking film 5 is preferred, and disposing both is more preferred.

The electron-blocking film 3 can be disposed between the lower electrodes 2 and the photoelectric conversion film 4. The electron-blocking film 3 can suppress electrons from being injected from the lower electrodes 2 into the photoelectric conversion film 4 and dark current from ending up increasing when the bias voltage has been applied between the lower electrodes 2 and the upper electrode 6.

Electron-donating organic materials can be used for the electron-blocking film 3.

It suffices for the material that is actually used for the electron-blocking film 3 to be selected in accordance with, for example, the material of the adjacent electrodes and the material of the adjacent photoelectric conversion film 4. As the material used for the electron-blocking film 3, a material whose electron affinity (Ea) is greater by 1.3 eV or more than the work function (Wf) of the material of the adjacent electrodes and has an ionization potential (Ip) equal to or smaller than the ionization potential of the material of the adjacent photoelectric conversion film 4 is preferred. Materials that can be applied as the electron-donating organic material are described in detail in JP-A No. 2009-32854, so description thereof will be omitted.

In order to allow the electron-blocking film 3 to reliably exhibit a dark current suppressing effect and to prevent a drop in the photoelectric conversion efficiency of the sensor portions 13, the thickness of the electron-blocking film 3 is preferably 10 nm to 200 nm, more preferably 30 nm to 150 nm, and particularly preferably 50 nm to 100 nm.

The hole-blocking film 5 can be disposed between the photoelectric conversion film 4 and the upper electrode 6. The hole-blocking film 5 can suppress holes from being injected from the upper electrode 6 into the photoelectric conversion film 4 and dark current from ending up increasing when the bias voltage has been applied between the lower electrodes 2 and the upper electrode 6.

Electron-accepting organic materials can be used for the hole-blocking film 5.

In order to allow the hole-blocking film 5 to reliably exhibit a dark current suppressing effect and to prevent a drop in the photoelectric conversion efficiency of the sensor portions 13, the thickness of the hole-blocking film 5 is preferably 10 nm to 200 nm, more preferably 30 nm to 150 nm, and particularly preferably 50 nm to 100 nm.

It suffices for the material that is actually used for the hole-blocking film 5 to be selected in accordance with, for example, the material of the adjacent electrode and the material of the adjacent photoelectric conversion film 4. As the material used for the hole-blocking film 5, a material whose ionization potential (Ip) is greater by 1.3 eV or more than the work function (Wf) of the material of the adjacent electrode and has an electron affinity (Ea) equal to or greater than the electron affinity of the material of the adjacent photoelectric conversion film 4 is preferred. Materials that can be applied as the electron-accepting organic material are described in detail in JP-A No. 2009-32854, so description thereof will be omitted.

In a case where the bias voltage is set in such a way that, from among the electric charge generated in the photoelectric conversion film 4, the holes move to the upper electrode 6 and the electrons move to the lower electrode 2, it suffices for the positions of the electron-blocking film 3 and the hole-blocking film 5 to be reversed. Further, the electron-blocking film 3 and the hole-blocking film 5 do not both have to be disposed; a certain degree of a dark current suppressing effect can be obtained as long as either is disposed.

The signal output portions 14 are formed on the front side of the substrate 1 below the lower electrodes 2 of each of the pixel portions.

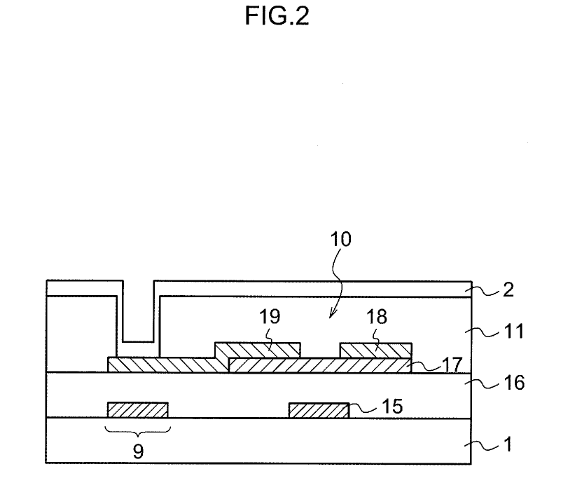

In FIG. 2, the configuration of the signal output portions 14 is schematically shown.

A capacitor 9 that stores the electric charge that has moved to the lower electrode 2 and a field-effect thin-film transistor (TFT; hereinafter this will also be simply called a “thin-film transistor”) 10 that converts the electric charge stored in the capacitor 9 into an electrical signal and outputs the electrical signal are formed in correspondence to the lower electrode 2. The region in which the capacitor 9 and the thin-film transistor 10 are formed has a section that coincides with the lower electrode 2 as seen in a plan view, and by giving the signal output portion 14 this configuration, the signal output portion 14 and the sensor portion 13 in each of the pixel portions come to lie on top of each another in the thickness direction. To minimize the plane area of the radiation detector 20 (the pixel portions), it is preferred that the region in which the capacitor 9 and the thin-film transistor 10 are formed be completely covered by the lower electrode 2.

The capacitor 9 is electrically connected to the corresponding lower electrode 2 via a wire of a conducting material that is formed penetrating an insulating film 11 disposed between the substrate 1 and the lower electrode 2. Because of this, the electric charge trapped in the lower electrode 2 can be moved to the capacitor 9.

In the thin-film transistor 10, a gate electrode 15, a gate insulating film 16, and an active layer (channel layer) 17 are layered, and moreover, a source electrode 18 and a drain electrode 19 are formed a predetermined spacing apart from each other on the active layer 17. Further, in the radiation detector 20, the active layer 17 is formed by an amorphous oxide. As the amorphous oxide configuring the active layer 17, an oxide including at least one of In, Ga, and Zn (e.g., In—O) is preferred, an oxide including at least two of In, Ga, and Zn (e.g., In—Zn—O, In—Ga—O, and Ga—Zn—O) is more preferred, and an oxide including In, Ga, and Zn is particularly preferred. As an In—Ga—Zn—O amorphous oxide, an amorphous oxide whose composition in a crystalline state is expressed by InGaO₃(ZnO)ₘ (where m is a natural number less than 6) is preferred, and particularly InGaZnO₄ is more preferred.

By forming the active layer 17 of the thin-film transistor 10 using an amorphous oxide, the active layer 17 does not absorb radiation such as X-rays, or if it does absorb any radiation the amount absorbed is only an extremely minute amount, so the generation of noise in the signal output portion 14 can be effectively suppressed.

Here, the amorphous oxide configuring the active layer 17 of the thin-film transistor 10 and the organic photoelectric conversion material configuring the photoelectric conversion film 4 can both be formed into films at a low temperature. Consequently, the substrate 1 is not limited to a substrate with high heat resistance, such as a semiconductor substrate, a quartz substrate, or a glass substrate, and flexible substrates of plastic or the like, aramids, or bio-nanofibers can also be used. Specifically, polyester, such as polyethylene terephthalate, polybutylene phthalate, and polyethylene naphthalate, polystyrene, polycarbonate, polyethersulphone, polyarylate, polyimide, polycyclic olefin, norbornene resin, and poly(chloro-trifluoro-ethylene) or other flexible substrates can be used. By using a flexible substrate made of plastic, the substrate can be made lightweight, which becomes advantageous for portability, for example.

Further, an insulating layer for ensuring insulation, a gas barrier layer for preventing the transmission of moisture and oxygen, an undercoat layer for improving flatness or adhesion to the electrodes or the like, and other layers may also be disposed on the substrate 1.

High-temperature processes reaching 200 degrees or higher can be applied to aramids, so a transparent electrode material can be hardened at a high temperature and given a low resistance, and aramids can also handle automatic packaging of driver ICs including solder reflow processes. Further, aramids have a thermal expansion coefficient that is close to that of indium tin oxide (ITO) or a glass substrate, so they have little warping after manufacture and do not break easily. Further, aramids can also form a thinner substrate compared to a glass substrate or the like. An ultrathin glass substrate and an aramid may also be layered to form the substrate 1.

Bio-nanofibers are composites of cellulose microfibril bundles (bacterial cellulose) that a bacterium (Acetobacter xylinum) produces and a transparent resin. Cellulose microfibril bundles have a width of 50 nm, which is a size that is 1/10 with respect to visible wavelengths, and have high strength, high elasticity, and low thermal expansion. By impregnating and hardening a transparent resin such as an acrylic resin or an epoxy resin in bacterial cellulose, bio-nanofibers exhibiting a light transmittance of about 90% at a wavelength of 500 nm while including fibers at 60 to 70% can be obtained. Bio-nanofibers have a low thermal expansion coefficient (3 to 7 ppm) comparable to silicon crystal, a strength comparable to steel (460 MPa), high elasticity (30 GPa), and are flexible, so they can form a thinner substrate 1 compared to a glass substrate or the like.

In the present embodiment, the radiation detector 20 is formed by forming the signal output portions 14, the sensor portions 13, and the transparent insulating film 7 in order on the substrate 1 and adhering the scintillator 8 on the substrate 1 using an adhesive resin or the like whose light absorbance is low. Below, the substrate 1 formed up to the transparent insulating film 7 will be called a TFT substrate 30

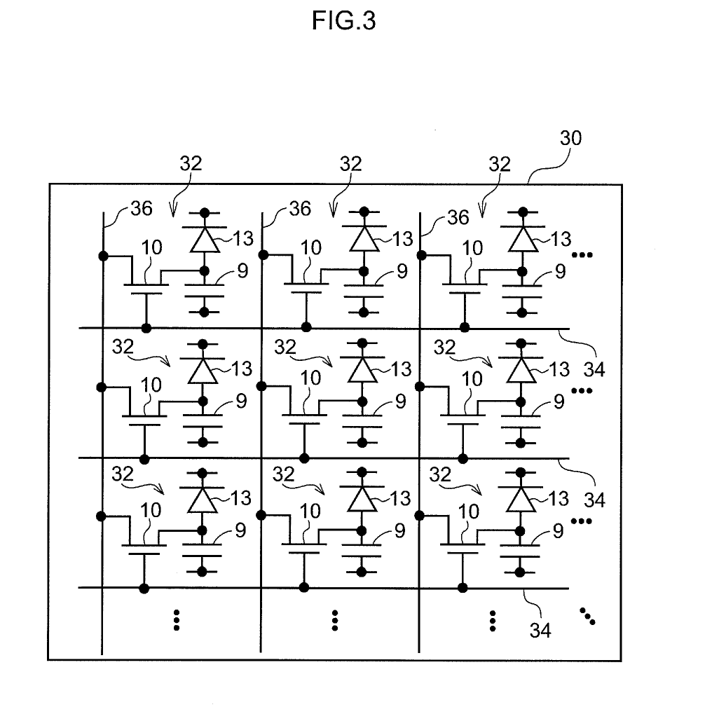

As shown in FIG. 3, on the TFT substrate 30, pixels 32 configured to include the sensor portions 13, the capacitors 9, and the thin-film transistors 10 are plurally disposed two-dimensionally in one direction (a row direction in FIG. 3) and an intersecting direction (a column direction in FIG. 3) with respect to the one direction.

Further, plural gate lines 34, which are disposed extending in the one direction (the row direction) and are for switching on and off the thin-film transistors 10, and plural data lines 36, which are disposed extending in the intersecting direction (the column direction) and are for reading out the electric charges via the thin-film transistors 10 in an on-state, are disposed in the radiation detector 20.

The radiation detector 20 is shaped like a flat plate and has a four-sided shape having four sides on its outer edge as seen in a plan view. Specifically, it is formed in the shape of a rectangle.

Next, the configuration of an imaging component 21 that captures radiographic images will be described.

The imaging component 21 pertaining to the present embodiment has two imaging systems that capture radiographic images represented by applied radiation and is configured in such a way that it can individually read out sets of image information representing the radiographic images captured by the imaging systems.

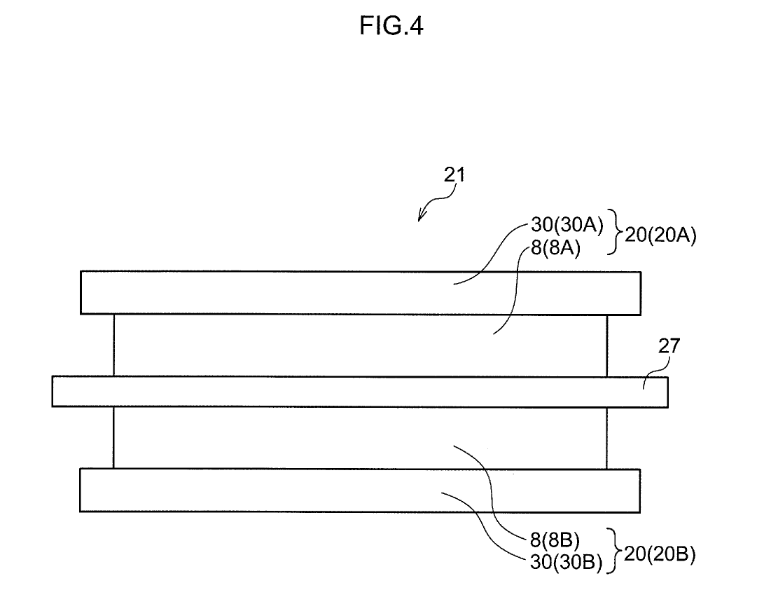

Specifically, as shown in FIG. 4, two radiation detectors 20 (20A and 20B) are placed in such a way that their scintillator 8 sides oppose each other, with a light-blocking plate 27 that allows radiation to pass through and blocks light being interposed in between. Below, in the case of distinguishing between the scintillators 8 and the TFT substrates 30 of the two radiation detectors 20A and 20B, the letter A will be added to the scintillator 8 and the TFT substrate 30 of the radiation detector 20A, and the letter B will be added to the scintillator 8 and the TFT substrate 30 of the radiation detector 20B.

In this way, because the scintillator 8A and the TFT substrate 30A are disposed in order on one side of the light-blocking plate 27, in the radiation detector 20A the application of the radiation from the one side becomes back side illumination. Because the scintillator 8B and the TFT substrate 30B are disposed in order on the other side of the light-blocking substrate 27, in the radiation detector 20B the application of the radiation from the other side becomes back side illumination. Further, by disposing the light-blocking plate 27 between the two radiation detectors 20A and 20B, the light generated by the scintillator 8A does not pass through to the scintillator 8B side and the light generated by the scintillator 8B does not pass through to the scintillator 8A side.

Here, the light emission characteristic of the scintillator 8 changes depending also on its thickness, so the thicker the scintillator 8 becomes, the greater the light emission amount of the scintillator 8 becomes and the higher the sensitivity of the scintillator 8 becomes, but image quality deteriorates because of light scattering and so forth.

Further, in a case where the scintillator 8 is formed by filling it with particles that emit light as a result of radiation being applied, such as GOS, for example, the larger the particle diameter of the particles is, the greater the light emission amount of the scintillator 8 becomes and the higher the sensitivity of the scintillator 8 becomes, but light scattering increases and affects adjacent pixels, so image quality deteriorates.

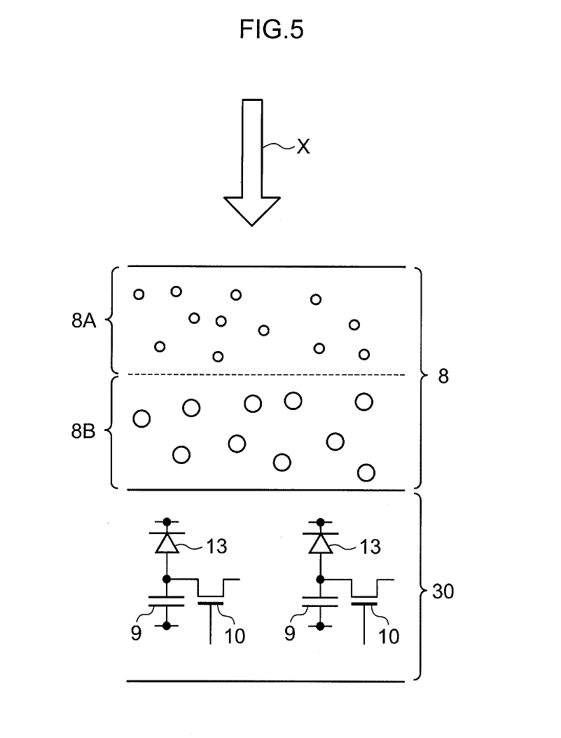

Further, the scintillator 8 can be given a multilayer structure of small particles and large particles. For example, as shown in FIG. 5, configuring the scintillator 8 in such a way that its illuminated side is a region 8A of small particles and its TFT substrate 30 side is a region 8B of large particles results in less image blur, but it is difficult for diagonal components of the light emitted radially by the small particles to reach the TFT substrate 30 and sensitivity decreases. Further, by changing the ratio of the region 8A and the region 8B to increase the layer of large particles with respect to the layer of small particles, the sensitivity of the scintillator 8 becomes higher, but light scattering affects the adjacent pixels, so image quality deteriorates.

Further, the higher the fill rate is, the higher the sensitivity of the scintillator 8 becomes, but light scattering increases and image quality deteriorates. Here, the fill rate is a value equal to the total volume of the particles of the scintillator 8 divided by the volume of the scintillator 8 multiplied by 100. In the scintillator 8, it is preferred that the fill rate be 50 to 80% by volume because it becomes difficult in terms of manufacture to handle powder when the fill rate exceeds 80%.

Further, the light emission characteristic of the scintillator 8 changes also depending on the doping amount of an activator, so there is a tendency for the light emission amount to increase the greater the doping amount of the activator becomes, but light scattering increases and image quality deteriorates.

Further, by changing the material used for the scintillator 8, the light emission characteristic with respect to radiation becomes different.

For example, by forming the scintillator 8A using GOS and forming the scintillator 8B using CsI(Tl), the scintillator 8A comes to have a sensitivity emphasis and the scintillator 8B comes to have an image quality emphasis.

Further, by giving the scintillator 8 a flat plate or column separation layer structure, the light emission characteristic with respect to radiation becomes different.

For example, by giving the scintillator 8A a flat plate layer structure and giving the scintillator 8B a column separation layer structure, the scintillator 8A comes to have a sensitivity emphasis and the scintillator 8B comes to have an image quality emphasis.

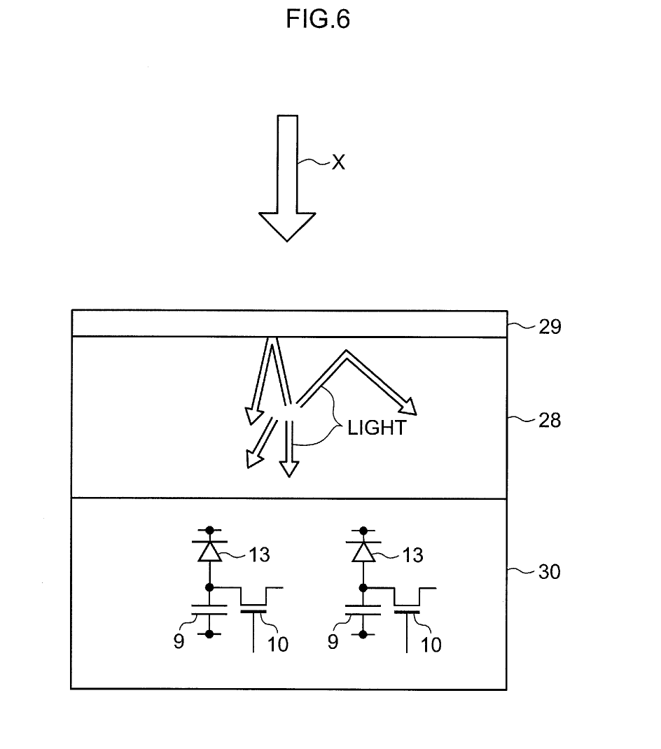

Further, as shown in FIG. 6, by forming a reflective layer 29 that allows X-rays to pass through and reflects visible light on the side of the scintillator 8 on the opposite side of the TFT substrate 30, the generated light can be more efficiently guided to the TFT substrate 30, so sensitivity improves. The method of disposing the reflective layer may be any of sputtering, deposition, and coating. As the reflective layer 29, a material whose reflectivity is high in the emission wavelength region of the scintillator 8 that is used, such as Au, Ag, Cu, Al, Ni, or Ti, is preferred. For example, in a case where the scintillator 8 comprises GOS:Tb, then a material such as Ag, Al, or Cu, whose reflectivity is high in the wavelength region of 400 to 600 nm, is good. As for the thickness of the reflective layer 29, reflectivity is not obtained with a thickness less than 0.01 μm, and further effects are not obtained in terms of improvements in reflectivity even if the thickness exceeds 3 μm, so 0.01 to 3 μm is preferred.

Here, it goes without saying that the scintillator 8 can have its characteristic made different by combining and performing a change to the particle diameter of the particles, the multilayer structure of the particles, the fill rate of the particles, the doping amount of the activator, the material, and the layer structure and the formation of the reflective layer 29.

Further, the light reception characteristics of the TFT substrates 30A and 30B with respect to light can be changed by changing the material of the photoelectric conversion film 4, or forming a filter between the TFT substrate 30A and the scintillator 8A and between the TFT substrate 30B and the scintillator 8B, or changing the light-receiving area of the sensor portions 13 between the TFT substrate 30A and the TFT substrate 30B to make the light-receiving area wider on the side with the sensitivity emphasis than on the side with the image quality emphasis, or changing the pixel pitch between the TFT substrate 30A and the TFT substrate 30B to make the pixel pitch narrower on the side with the image quality emphasis than on the side with the sensitivity emphasis, or changing the signal read-out characteristics of the TFT substrates 30A and 30B.

In the present embodiment, the characteristics of the radiographic images captured by the radiation detectors 20A and 20B are made different by changing the thickness of the scintillators 8A and 8B, the particle diameter of the particles, the multilayer structure of the particles, the fill rate of the particles, the doping amount of the activator, the material, and the layer structure, or forming the reflective layer 29, or forming a filter between the TFT substrate 30A and the scintillator 8A and between the TFT substrate 30B and the scintillator 8B, or changing the light-receiving area of the sensor portions 13 between the TFT substrate 30A and the TFT substrate 30B to make the light-receiving area wider on the side with the sensitivity emphasis than on the side with the image quality emphasis, or changing the pixel pitch between the TFT substrate 30A and the TFT substrate 30B to make the pixel pitch narrower on the side with the image quality emphasis than on the side with the sensitivity emphasis.

Specifically, the radiation detector 20A is given an image quality emphasis and the radiation detector 20B is given a sensitivity emphasis.

Next, the configuration of a portable radiographic imaging device (called an “electronic cassette” below) 40 that has the imaging component 21 built into it and captures radiographic images will be described.

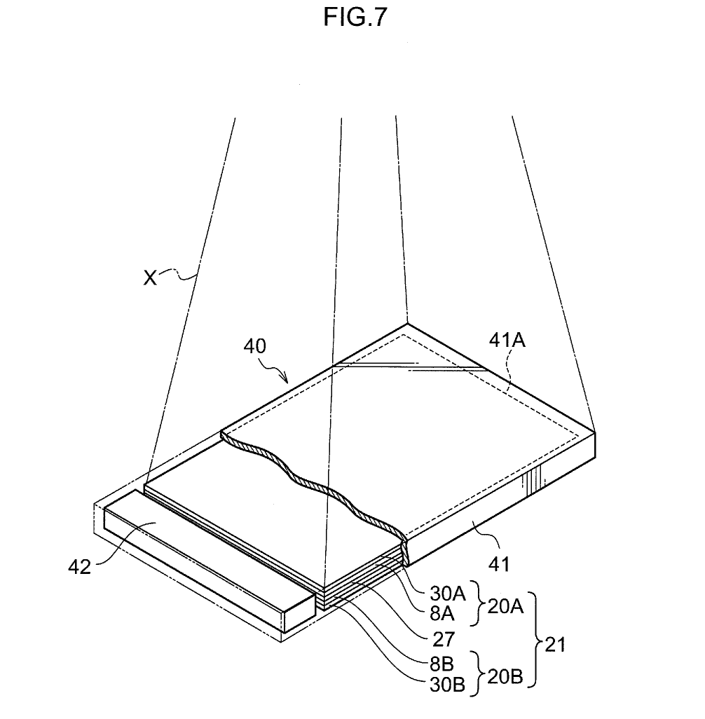

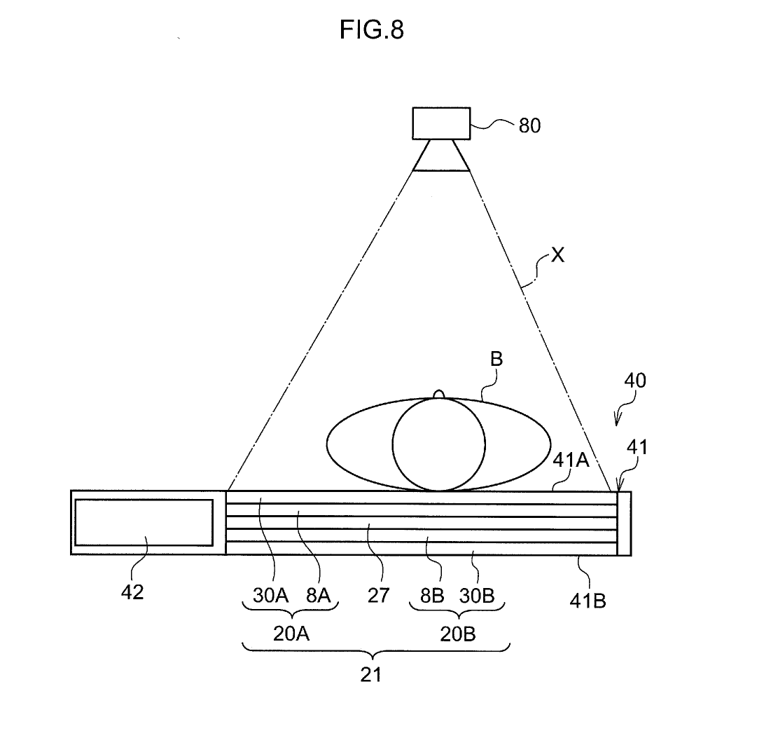

In FIG. 7, there is shown a perspective view showing the configuration of the electronic cassette 40, and in FIG. 8, there is shown a cross-sectional view of the electronic cassette 40.

The electronic cassette 40 is equipped with a flat plate-shaped casing 41 comprising a material that allows radiation to pass through, and the electronic cassette 40 is given a waterproof and airtight structure. The imaging component 21 is disposed inside the casing 41 of the electronic cassette 40. In the casing 41, regions corresponding to the disposed position of the imaging component 21 on one side and on the other side of the flat plate shape are imaging regions 41A and 41B to which radiation is applied at the time of imaging. As shown in FIG. 8, the imaging component 21 is built into the casing 41 in such a way that the radiation detector 20A is on the imaging region 41A side of the light-blocking plate 27; the imaging region 41A is an imaging region with an image quality emphasis and the imaging region 41B is an imaging region with a sensitivity emphasis.

Further, a case 42 that accommodates a cassette control component 58 and a power source component 70 described later is placed on one end side of the inside of the casing 41 in a position that does not coincide with the imaging component 21 (outside the range of the imaging region 41A).

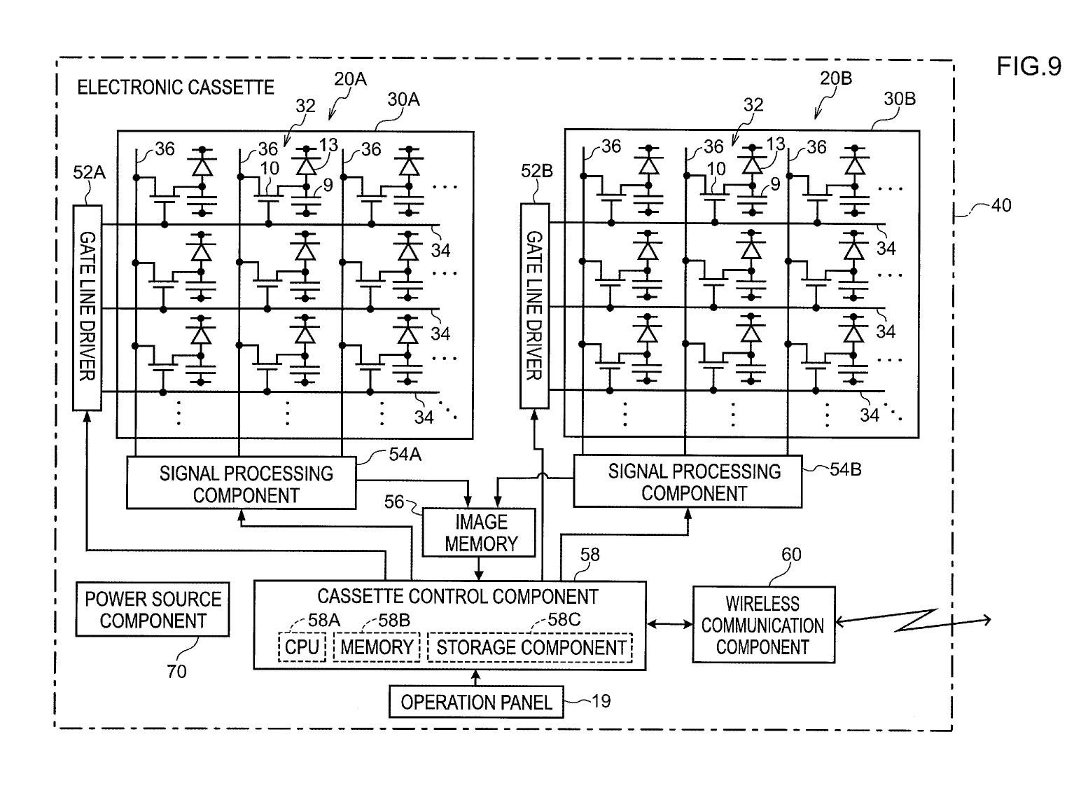

In FIG. 9, there is shown a block diagram showing the configurations of main portions of an electrical system of the electronic cassette 40 pertaining to the present embodiment.

In the radiation detectors 20A and 20B, a gate line driver 52 is placed on one side of two sides adjacent to each other, and a signal processing component 54 is placed on the other side. Below, in the case of distinguishing between the gate line drivers 52 and the signal processing components 54 disposed in correspondence to the two radiation detectors 20A and 20B, the letter A will be added to the gate line driver 52 and the signal processing component 54 corresponding to the radiation detector 20A and the letter B will be added to the gate line driver 52 and the signal processing component 54 corresponding to the radiation detector 20B.

The individual gate lines 34 of the TFT substrate 30A are connected to the gate line driver 52A, and the individual data lines 36 of the TFT substrate 30A are connected to the signal processing component 54A. The individual gate lines 34 of the TFT substrate 30B are connected to the gate line driver 52B, and the individual data lines 36 of the TFT substrate 30B are connected to the signal processing component 54B.

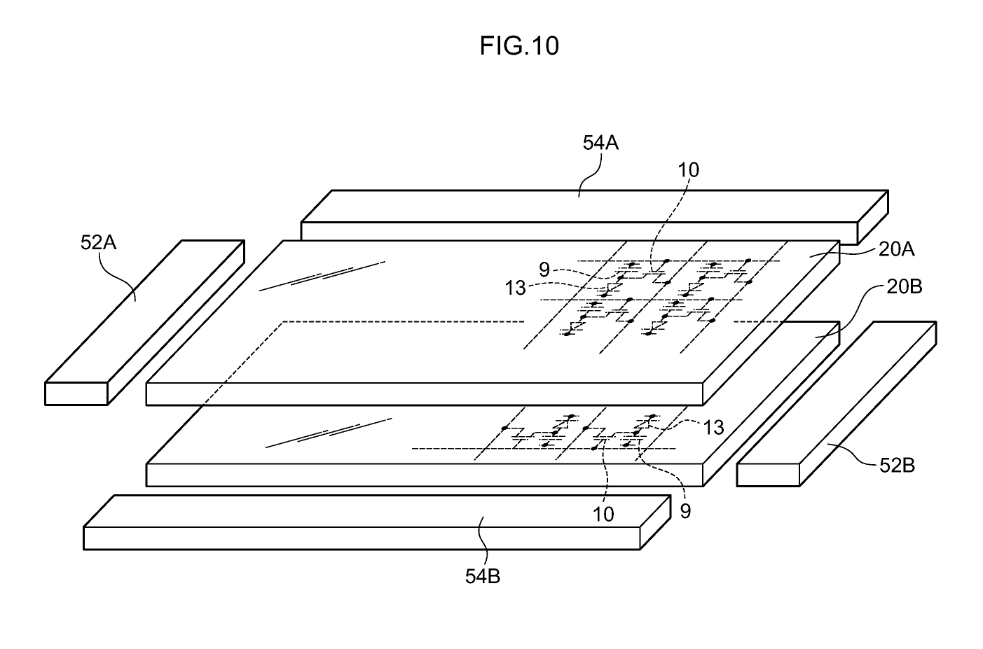

The gate line drivers 52A and 52B and the signal processing components 54A and 54B give off heat. Therefore, as shown in FIG. 10, when layering the radiation detectors 20A and 20B, one is rotated 180 degrees with respect to the other so that the gate line drivers 52A and 52B and the signal processing components 54A and 54B are placed in such a way that the gate line driver 52A and the gate line driver 52B do not lie on top of each other and the signal processing component 54A and the signal processing component 54B do not lie on top of each other. In this way, suppressing the effects of the heat of both is preferred.

The thin-film transistors 10 of the TFT substrates 30A and 30B are switched on in order in row units by signals supplied via the gate lines 34 from the gate line drivers 52A and 52B. The electric charges that have been read out by the thin-film transistors 10 switched to an on-state are transmitted through the data lines 36 as electrical signals and are input to the signal processing components 54A and 54B. Because of this, the electric charges are read out in order in row units, and two-dimensional radiographic images become acquirable.

Although they are not shown in the drawings, the signal processing components 54A and 54B are equipped with amplification circuits that amplify the input electrical signals and sample-and-hold circuits for each of the individual data lines 36. The electrical signals that have been transmitted through the individual data lines 36 are amplified by the amplification circuits and are thereafter held in the sample-and-hold circuits. Further, multiplexers and analog-to-digital (A/D) converters are connected in order to the output sides of the sample-and-hold circuits. The electrical signals held in the individual sample-and-hold circuits are input in order (serially) to the multiplexers and are converted into digital image data by the A/D converters.

Further, an image memory 56, a cassette control component 58, and a wireless communication component 60 are disposed inside the casing 41.

The image memory 56 is connected to the signal processing components 54A and 54B, and the image data that have been output from the A/D converters of the signal processing components 54A and 54B are stored in order in the image memory 56. The image memory 56 has a storage capacity that can store a predetermined number of frames' worth of image data, and each time radiographic imaging is performed, the image data obtained by the imaging are sequentially stored in the image memory 56.

The image memory 56 is also connected to the cassette control component 58. The cassette control component 58 is configured by a microcomputer, is equipped with a central processing unit (CPU) 58A, a memory 58B including a ROM and a RAM, and a non-volatile storage component 58C comprising a flash memory or the like, and controls the actions of the entire electronic cassette 40.

Further, the wireless communication component 60 is connected to the cassette control component 58. The wireless communication component 60 is compatible with a wireless local area network (LAN) standard represented by the Institute of Electrical and Electronics Engineers (IEEE) 802.11a/b/g standard or the like and controls the transmission of various types of information between the electronic cassette 40 and external devices by wireless communication. The cassette control component 58 can wirelessly communicate with external devices, such as a console that controls radiographic imaging overall, via the wireless communication component 60 and can transmit and receive various types of information to and from the console via the wireless communication component 60.

Further, a power source component 70 is disposed in the electronic cassette 40, and the various circuits and elements described above (the gate line drivers 52, the signal processing components 54, the image memory 56, the wireless communication component 60, the microcomputer functioning as the cassette control component 58, etc.) operate on power supplied from the power source component 70. The power source component 70 has a built-in battery (a rechargeable secondary battery) so as to not impair the portability of the electronic cassette 40, and the power source component 70 supplies power to the various circuits and elements from the charged battery. In FIG. 9, illustration of wires connecting the various circuits and elements to the power source component 70 is omitted.

The cassette control component 58 individually controls the actions of the gate line drivers 52A and 52B and can individually control the reading-out of the image information representing the radiographic images from the TFT substrates 30A and 30B.

Next, the action of the electronic cassette 40 pertaining to the present embodiment will be described.

When capturing a radiographic image, the electronic cassette 40 pertaining to the present embodiment can perform imaging using only either one of the radiation detectors 20A and 20B and can perform imaging using both of the radiation detectors 20A and 20B.

Further, when performing imaging using both of the radiation detectors 20A and 20B, the electronic cassette 40 can generate an energy subtraction image by performing image processing that performs weighted addition, per corresponding pixel, of the radiographic images captured by the radiation detectors 20A and 20B.

The imaging region 41A with the image quality emphasis and the imaging region 41B with the sensitivity emphasis are disposed in the electronic cassette 40. By reversing the entire electronic cassette 40, the electronic cassette 40 can capture a radiographic image with the imaging region 41A or the imaging region 41B.

Further, the electronic cassette 40 can individually retain the sets of image information representing the radiographic images captured by the radiation detectors 20A and 20B and the image information of the energy subtraction image it has generated.

When capturing a radiographic image, the radiographer designates, as the captured image, any of the image quality emphasis, the sensitivity emphasis, and the energy subtraction image depending on the intended use with respect to the console. Further, when the radiographer has designated the energy subtraction image as the captured image, the radiographer designates the implementation or non-implementation of image processing that generates the energy subtraction image in the electronic cassette 40 with respect to the console. Moreover, the radiographer designates the implementation or non-implementation of retention of the image information captured in the electronic cassette 40 with respect to the console.

The console transmits, as processing conditions to the electronic cassette 40, the designated captured image, the implementation or non-implementation of image processing that generates the energy subtraction image, and the implementation or non-implementation of retention of the image information.

The electronic cassette 40 stores the transmitted processing conditions in the storage component 58C.

The imaging region 41A with the image quality emphasis and the imaging region 41B with the sensitivity emphasis are disposed in the electronic cassette 40. By reversing the entire electronic cassette 40, the electronic cassette 40 can capture a radiographic image with the imaging region 41A or the imaging region 41B.

The electronic cassette 40 is placed in such a way that, as shown in FIG. 8, it is spaced apart from a radiation generator 80 that generates radiation, with the imaging region 41A face-up in the case of performing imaging with the image quality emphasis and capturing the energy subtraction image and with the imaging region 41B face-up in the case of performing imaging with the sensitivity emphasis. Further, an imaging target site B of a patient is placed on the imaging region. The radiation generator 80 emits a dose of radiation corresponding to imaging conditions given beforehand. The radiation X emitted from the radiation generator 80 carries image information as a result of passing through the imaging target site B and is thereafter applied to the electronic cassette 40.

The radiation X applied from the radiation generator 80 passes through the imaging target site B and thereafter reaches the electronic cassette 40. Because of this, electric charges corresponding to the dose of the applied radiation X are generated in the sensor portions 13 of the radiation detector 20 built into the electronic cassette 40, and the electric charges generated in the sensor portions 13 are stored in the capacitors 9.

After the application of the radiation X ends, the cassette control component 58 performs image read-out processing that reads out the image in accordance with the processing conditions stored in the storage component 58C.

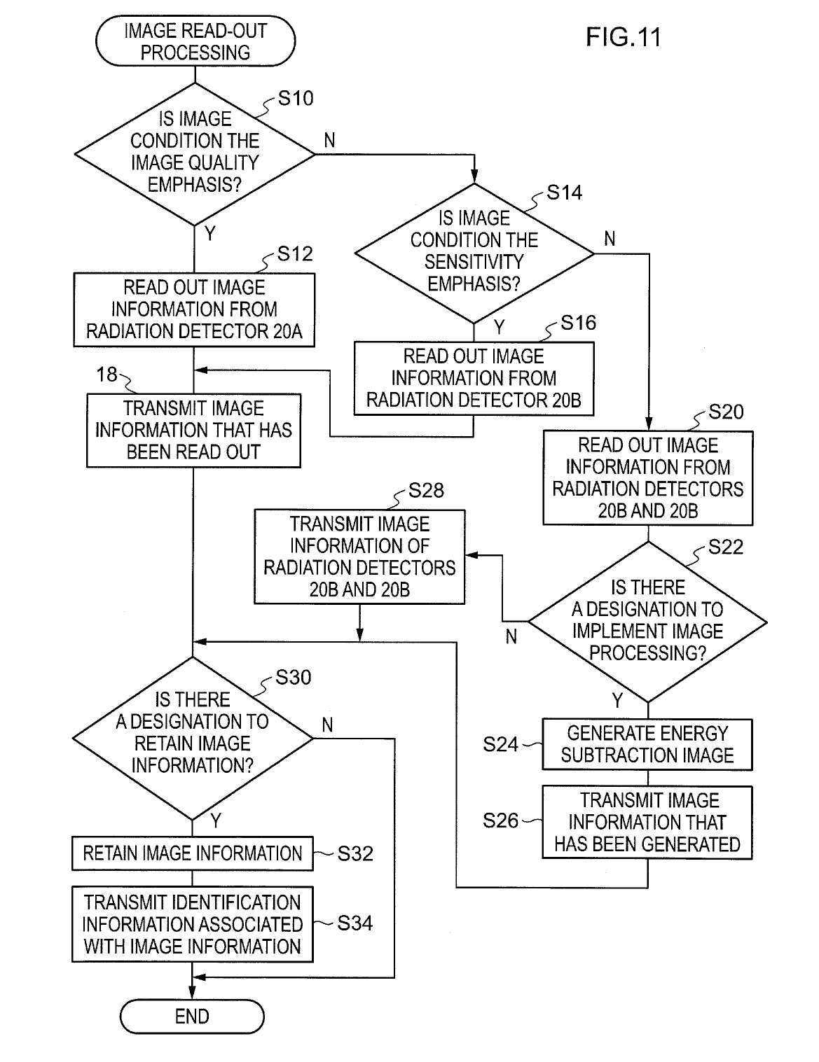

In FIG. 11, there is shown a flowchart showing a flow of processing of an image read-out processing program executed by the CPU 58A. The program is stored beforehand in a predetermined region of the ROM of the memory 58.

In step S10, the CPU 58A determines whether or not the captured image designated as a processing condition is the image quality emphasis; in a case where the determination is YES, the CPU 58A moves to step S12, and in a case where the determination is NO, the CPU 58A moves to step S14.

In step S12, the CPU 58A controls the gate line driver 52A to cause ON signals to be output in order one line at a time from the gate line driver 52A to the gate lines 40 of the radiation detector 20A that is the image quality emphasis characteristic to thereby read out the image information. The image information read out from the radiation detector 20A is stored in the image memory 56.

In step S14, the CPU 58A determines whether or not the captured image designated as a processing condition is the sensitivity emphasis; in a case where the determination is YES, the CPU 58A moves to step S16, and in a case where the determination is NO, the CPU 58A moves to step S20.

In step S16, the CPU 58A controls the gate line driver 52B to cause ON signals to be output in order one line at a time from the gate line driver 52B to the gate lines 40 of the radiation detector 20B that is the sensitivity emphasis characteristic to thereby read out the image information. The image information read out from the radiation detector 20B is stored in the image memory 56.

In step S18, the CPU 58A transmits the image information stored in the image memory 56 to the console.

Because of this, the image information of the radiographic image captured with the image quality emphasis characteristic by the radiation detector 20A or the image information of the radiographic image captured with the sensitivity emphasis characteristic by the radiation detector 20B is transmitted to the console.

In step S20, the CPU 58A regards the captured image designated as a processing condition to be the energy subtraction image and controls both of the gate line drivers 52A and 52B to cause ON signals to be output in order one line at a time to the gate lines 40 of the radiation detectors 20A and 20B to thereby read out the sets of image information. The sets of image information read out from the radiation detectors 20A and 20B are both stored in the image memory 56.

In step S22, the CPU 58A determines whether or not implementation of the image processing that generates the energy subtraction image is designated as a processing condition; in a case where the determination is YES, the CPU 58A moves to step S24, and in a case where the determination is NO, the CPU 58A moves to step S28.

In step S24, the CPU 58A generates the energy subtraction image by performing weighted addition, per corresponding pixel of the radiographic images, with respect to the sets of image information resulting from the radiation detectors 20A and 20B stored in the image memory 56.

In the next step S26, the CPU 58A transmits the image information of the generated energy subtraction image to the console.

In step S28, the CPU 58A transmits the sets of image information resulting from the radiation detectors 20A and 20B stored in the image memory 56 to the console. The console can generate the energy subtraction image by performing weighted addition, per corresponding pixel of the radiographic images, with respect to the sets of image information resulting from the radiation detectors 20A and 20B that have been transmitted. Further, the console can obtain the image information of the radiographic image captured with the image quality emphasis characteristic by the radiation detector 20A and the image information of the radiographic image captured with the sensitivity emphasis characteristic by the radiation detector 20B.

In step S30, the CPU 58A determines whether or not retention of the image information is designated as a processing condition; in a case where the determination is YES, the CPU 58A moves to step 32, and in a case where the determination is NO, the CPU 58A ends the processing.

In step S32, the CPU 58A associates identification information for identifying the image information and stores the image information read out in step S12, step S16, or step S20 in the storage component 58C.

In step S34, the CPU 58A transmits the identification information it associated with the image information in step S32 to the console and ends the processing.

The console stores the transmitted identification information, and when it wants to read out the image information stored in the electronic cassette 40, it transmits the identification information to the electronic cassette 40.

When the electronic cassette 40 receives the identification information transmitted from the console, the electronic cassette 40 reads out the image information associated with the identification information from the storage component 58C and transmits the image information to the console.

Because of this, the image information of the radiographic image captured by the electronic cassette 40 can be obtained again.

It is preferred that the electronic cassette 40 decide a retention period in which it will retain the image information in the storage component 58C as being until a predetermined period elapses or until the next imaging is performed, for example, and that the electronic cassette 40 notify the console of the retention period.

In this way, the electronic cassette 40 pertaining to the present embodiment can capture a radiographic image with an image quality emphasis, a radiographic image with a sensitivity emphasis, and an energy subtraction image, so the electronic cassette 40 can be used for several intended uses.

Further, as shown in FIG. 8, the radiation detectors 20A and 20B are built into the electronic cassette 40 pertaining to the present embodiment in such a way that the radiation detector 20A is back-side illuminated with respect to the imaging region 41A and the radiation detector 20B is back-side illuminated with respect to the imaging region 41B.

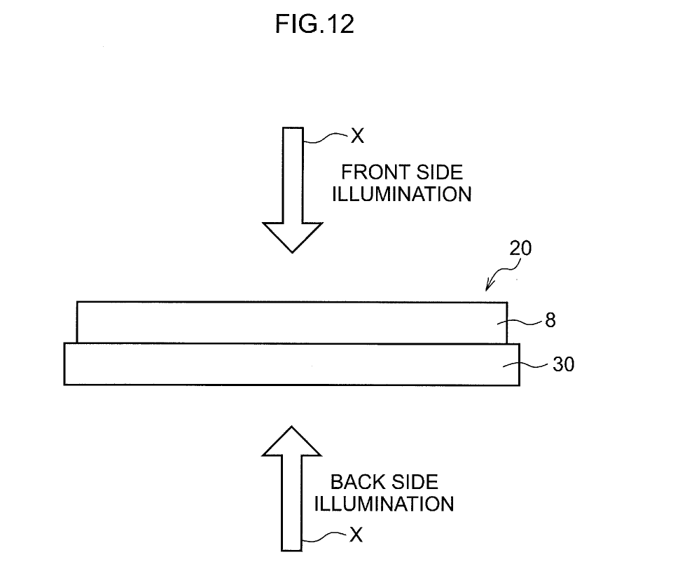

Here, as shown in FIG. 12, in a case where the radiation X is applied to the radiation detector 20 from the front side on which the scintillator 8 is formed (front side illumination), light is emitted more strongly on the upper side of the scintillator 8 (the opposite side of the TFT substrate 30). In a case where the radiation X is applied to the radiation detector 20 from the TFT substrate 30 side (back side) (back side illumination), the radiation X that has passed through the TFT substrate 30 is made incident on the scintillator 8, and the TFT substrate 30 side of the scintillator 8 emits light more strongly. In the sensor portions 13 disposed on the TFT substrate 30, electric charges are generated by the light generated by the scintillator 8. For this reason, the light emission position of the scintillator 8 with respect to the TFT substrate 30 is closer in a case where the radiation X is applied from the back side of the radiation detector 20 than in a case where the radiation X is applied from the front side of the radiation detector 20, so the resolution of the radiographic image obtained by imaging is higher.

Further, in the imaging component 21 pertaining to the present embodiment, the photoelectric conversion films 4 of the radiation detectors 20A and 20B are configured by an organic photoelectric conversion material, and virtually no radiation is absorbed by the photoelectric conversion films 4. For this reason, in the radiation detectors 20A and 20B, the amount of radiation absorbed by the photoelectric conversion films 4 is small even in a case where the radiation passes through the TFT substrate 30 because of back side illumination, so a drop in sensitivity with respect to the radiation X can be suppressed. In back side illumination, the radiation passes through the TFT substrate 30 and reaches the scintillator 8, but in a case where the photoelectric conversion film 4 of the TFT substrate 30 is configured by an organic photoelectric conversion material in this way, there is virtually no absorption of the radiation by the photoelectric conversion film 4 and attenuation of the radiation can be kept small, so configuring the photoelectric conversion film 4 with an organic photoelectric conversion material is suited to back side illumination.

Further, the amorphous oxide configuring the active layers 17 of the thin-film transistors 10 and the organic photoelectric conversion material configuring the photoelectric conversion film 4 can both be formed into films at a low temperature. For this reason, the substrate 1 can be formed by plastic resin, aramids, or bio-nanofibers in which there is little absorption of radiation. In the substrate 1 formed in this way, the amount of radiation absorbed is small, so a drop in sensitivity with respect to the radiation X can be suppressed even in a case where the radiation passes through the TFT substrate 30 because of back side illumination.

The present invention has been described above using the embodiment, but the technical scope of the present invention is not limited to the scope described in the above embodiment. A variety of changes or improvements can be made to the above embodiment without departing from the gist of the invention, and the technical scope of the present invention also includes embodiments to which such changes or improvements have been made.

Further, the above embodiment is not intended to limit the inventions pertaining to the claims, and it is not the case that all combinations of features described in the embodiment are essential to the solution of the invention. The above embodiment includes inventions of a variety of stages, and a variety of inventions can be extracted by appropriate combinations of the plural configural requirements disclosed. Even when several configural requirements are omitted from all the configural requirements described in the embodiment, configurations from which those several configural requirements have been omitted can also be extracted as inventions as long as effects are obtained.

In the above embodiment, a case was described where the present invention was adapted to the electronic cassette 40 that is a portable radiographic imaging device, but the present invention is not limited to this and may also be applied to a stationary radiographic imaging device.

Further, in the above embodiment, a case was described where the energy subtraction image is generated by performing image processing that performs weighted addition, per corresponding pixel, with respect to the sets of image information representing the radiographic images captured by the radiation detectors 20A and 20B. However, the present invention is not limited to this. For example, image processing that performs addition, per corresponding pixel, with respect to the sets of image information representing the radiographic images captured by the radiation detectors 20A and 20B may also be performed. By adding the sets of image information captured by the radiation detectors 20A and 20B, the amount of noise included in the images relatively decreases, so image quality improves. In this case, in the imaging component 21, it is preferred that the thickness of the scintillators 8A and 8B, the particle diameter of the particles, the multilayer structure of the particles, the fill rate of the particles, the doping amount of the activator, the material, and the layer structure be adjusted in such a way that the characteristics of the radiographic images captured by the radiation detectors 20A and 20B become substantially identical when the radiation has been applied from the imaging region 41A side.

Further, in the above embodiment, a case was described where the photoelectric conversion films 4 of the radiation detectors 20A and 20B were configured by an organic photoelectric conversion material, but the present invention is not limited to this. The photoelectric conversion film 4 and the active layers 17 of the thin-film transistors 10 of one of the radiation detectors 20 may also be configured by an impurity-doped semiconductor such as impurity-doped amorphous silicon. For example, as shown in FIG. 8, in a case where the radiation is applied from the imaging region 41A side and imaging by both of the radiation detectors 20A and 20B is performed, the photoelectric conversion film 4 of the radiation detector 20A placed on the upstream side with respect to the radiation applied from the imaging region 41A side at the time of the imaging may be configured by an organic photoelectric conversion material and the photoelectric conversion film 4 and the active layers 17 of the thin-film transistors 10 of the radiation detector 20B placed on the downstream side with respect to the radiation may be configured by an impurity-doped semiconductor. In this case, virtually no radiation is absorbed by the photoelectric conversion film 4 of the radiation detector 20A placed on the upstream side, so a drop in sensitivity with respect to the radiation X of the radiation detector 20B placed on the downstream side can be suppressed. Further, strong radiation is applied to the radiation detector 20A on the upstream side compared to the downstream side, but virtually no X-rays are absorbed by the organic photoelectric conversion material, so there is little deterioration resulting from the X-rays. In particular, in back side illumination, strong X-rays pass through the TFT substrate 30, but in a case where the photoelectric conversion film 4 is configured by an organic photoelectric conversion material, there is little deterioration resulting from the X-rays, so the life span of the radiation detector 20 can be extended.

Further, the radiation detectors 20A and 20B may also be adhered to each other inside the casing 41 in such a way that the TFT substrates 30 are on the imaging region 41A and 41B sides. In a case where the substrate 1 is formed by plastic resin, aramids, or bio-nanofibers whose rigidity is high, the rigidity of the radiation detectors 20 themselves is high, so the imaging region 41A and 41B sections of the casing 41 can be formed thin. Further, in a case where the substrate 1 is formed by plastic resin, aramids, or bio-nanofibers whose rigidity is high, the radiation detectors 20 themselves have flexibility, so it is difficult for the radiation detectors 20 to sustain damage even in a case where shock has been imparted to the imaging regions 41A and 41B.

Further, in the above embodiment, a case was described where the radiation detector 20A was given the image quality emphasis, the imaging region 41A was configured as the imaging region with the image quality emphasis, the radiation detector 20B was given the sensitivity emphasis, and the imaging region 41B was configured as the imaging region with the sensitivity emphasis, but the present invention is not limited to this. The radiation detectors 20 in which the photoelectric conversion film 4 and the active layers 17 of the thin-film transistors 10 are configured by an impurity-doped semiconductor as described above have excellent responsiveness and are suited to capturing moving images. For this reason, for example, the photoelectric conversion film 4 of the radiation detector 20A may be configured by an organic photoelectric conversion material, and the imaging region 41A may be configured as an imaging region for capturing still images. Further, the photoelectric conversion film 4 and the active layers 17 of the thin-film transistors 10 of the radiation detector 20B may be configured by an impurity-doped semiconductor, and the imaging region 41B may be configured as an imaging region for capturing moving images.

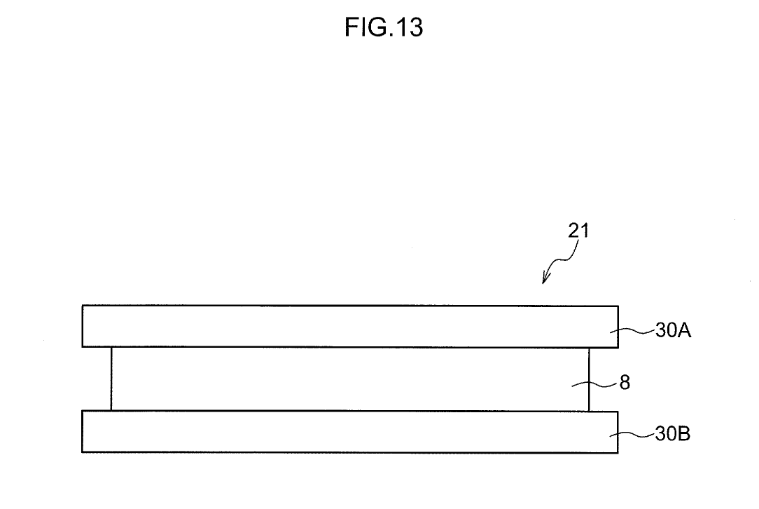

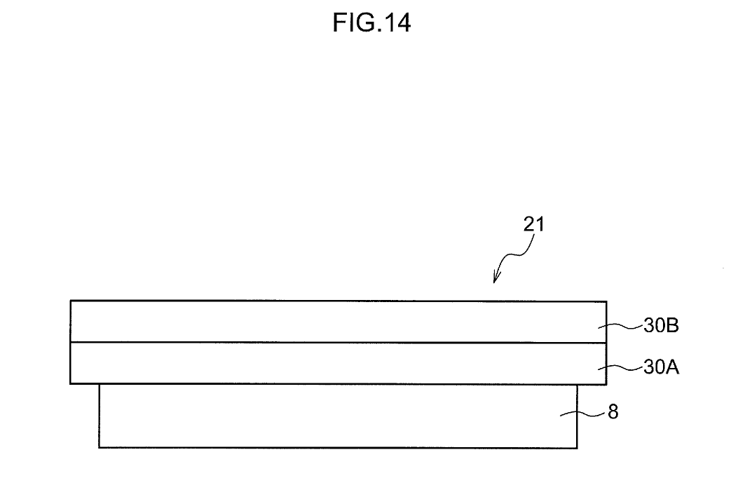

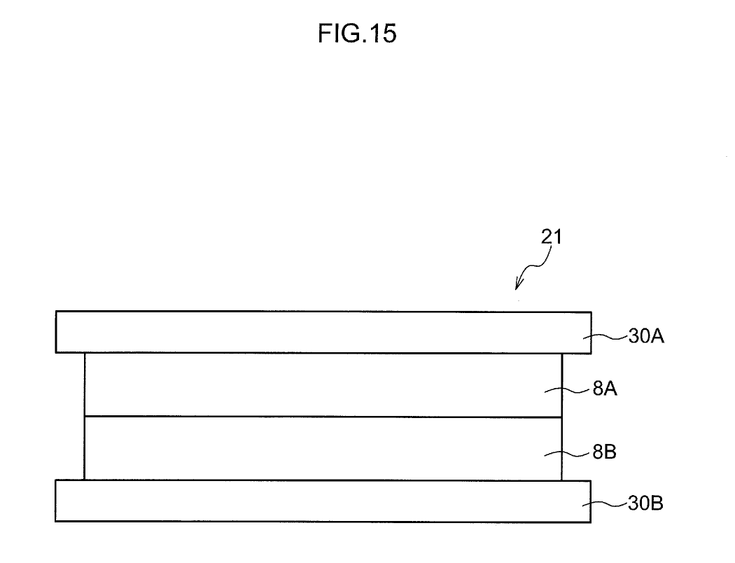

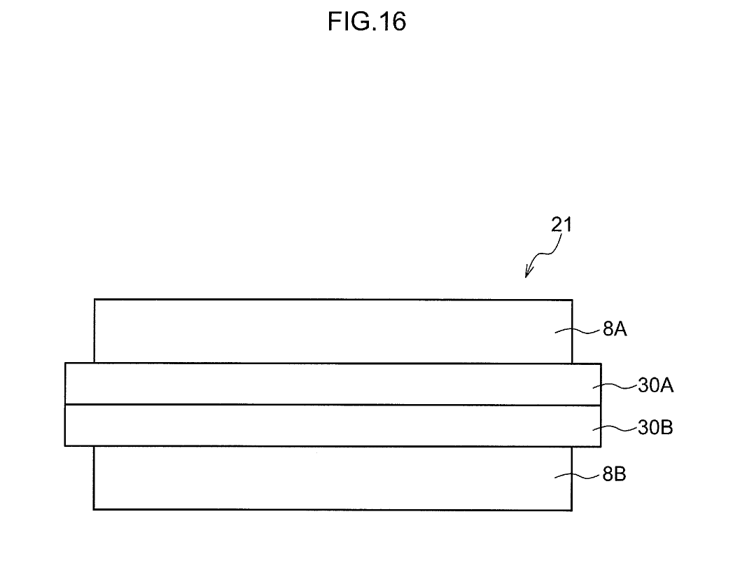

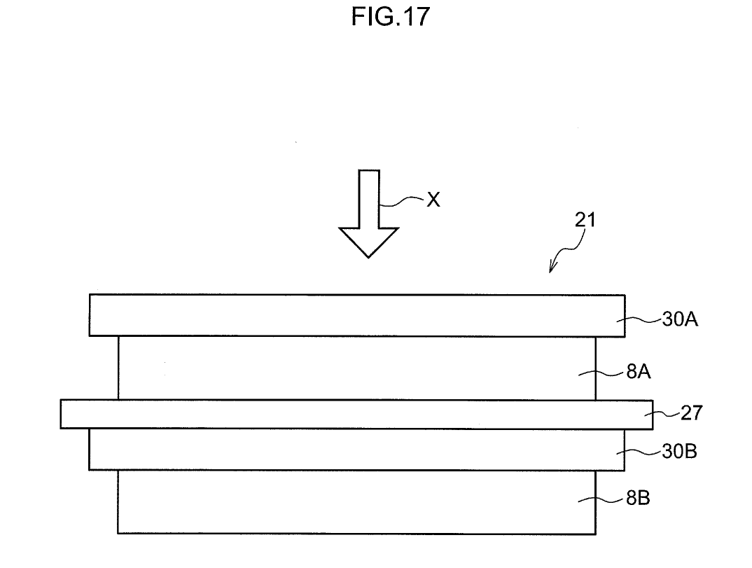

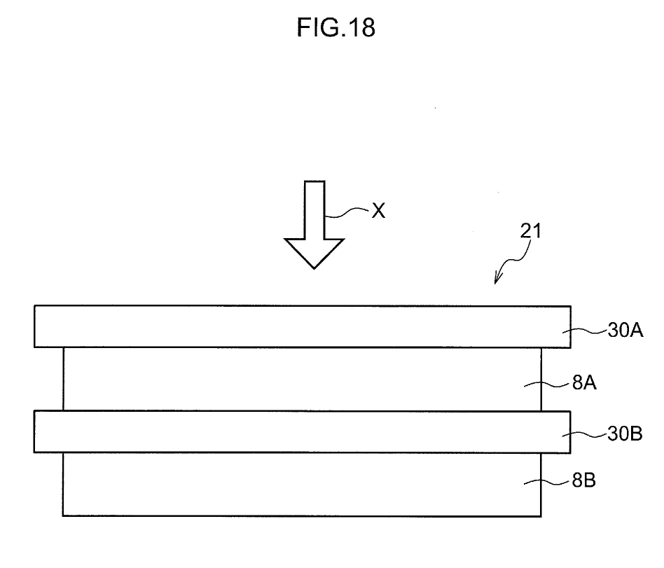

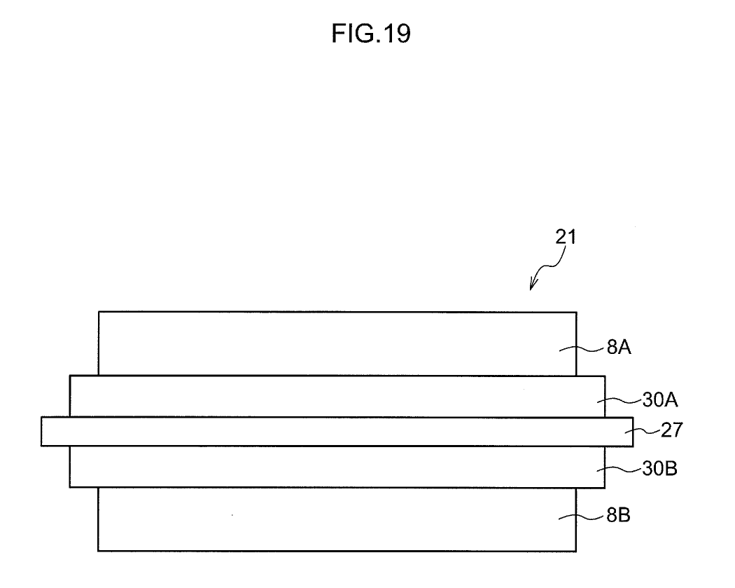

Further, in the above embodiment, a case was described where the imaging component 21 was given a configuration in which the two radiation detectors 20A and 20B were placed in such a way that their scintillator 8 sides opposed each other with the light-blocking plate 27 in between, but the present invention is not limited to this. For example, as shown in FIG. 13, the imaging component 21 may also be given a configuration in which the TFT substrate 30A is placed on one side of one scintillator 8 and the TFT substrate 30B is placed on the other side of the scintillator 8. Further, as shown in FIG. 14, the imaging component 21 may also be given a configuration in which the TFT substrates 30A and 30B are placed on one side of one scintillator 8. In this case, it is necessary that at least the TFT substrate 30A allows light to pass through. Further, in a case where the radiation detectors 20A and 20B are little affected by the light of one scintillator 8 on the other, as shown in FIG. 15, the imaging component 21 may also be given a configuration in which the light-blocking plate 27 is not disposed and the radiation detectors 20A and 20B are placed in such a way that the scintillators 8A and 8B face each other. Further, as shown in FIG. 16, the imaging component 21 may also be given a configuration in which the radiation detectors 20A and 20B are placed in such a way that the TFT substrates 30A and 30B face each other. Further, in a case where the electronic cassette 40 performs imaging with the radiation detectors 20A and 20B such as for obtaining an energy subtraction image, as shown in FIG. 17, the radiation detectors 20A and 20B may also be layered in such a way that they become back-side illuminated with respect to the radiation X with the light-blocking plate 27 in between. Further, as shown in FIG. 18, the radiation detectors 20A and 20B may also be layered in such a way that they become back-side illuminated with respect to the radiation X without the light-blocking plate 27 being disposed. Further, as shown in FIG. 19, the radiation detectors 20A and 20B may also be layered in such a way that they become front-side illuminated with the light-blocking plate 27 in between.

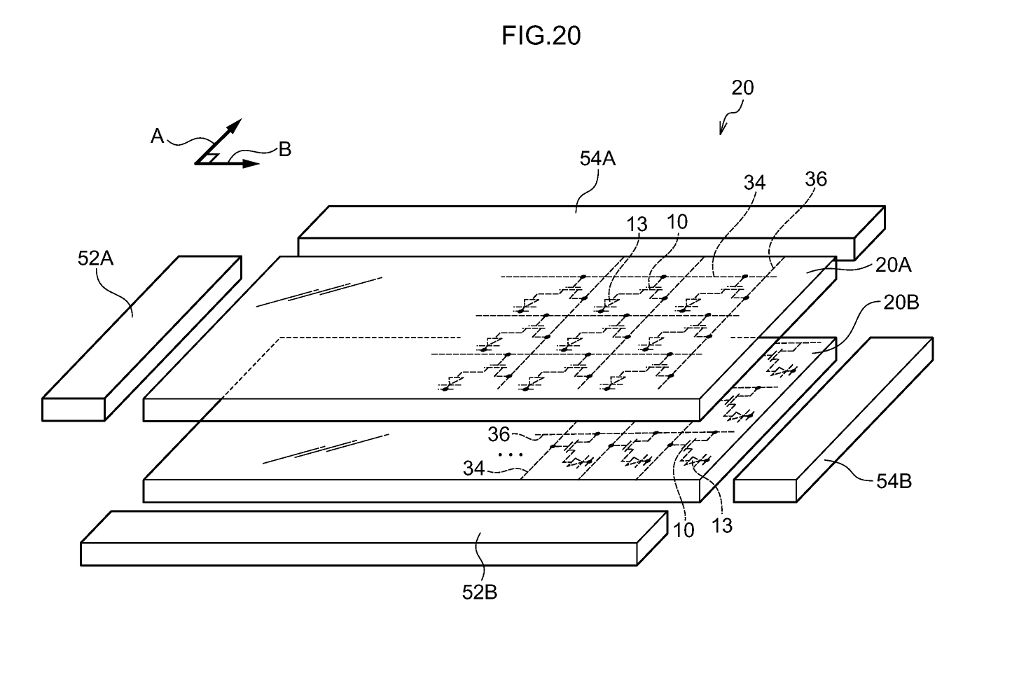

Further, in the above embodiment, as shown in FIG. 10, a case was described where, when layering the radiation detectors 20A and 20B, one is rotated 180 degrees with respect to the other so that the radiation detectors 20A and 20B are placed in such a way that the gate line driver 52A and the gate line driver 52B do not lie on top of each other and the signal processing component 54A and the signal processing component 54B do not lie on top of each other, but the present invention is not limited to this. For example, as shown in FIG. 20, when layering the radiation detectors 20A and 20B, one may be rotated 90 degrees with respect to the other so that the signal processing component 54B of the TFT substrate 30B is disposed on the edge on the opposite side of the signal processing component 54A of the TFT substrate 30A and the radiation detectors 20A and 20B are placed in such a way that the gate line driver 52A and the gate line driver 52B do not lie on top of each other and the signal processing component 54A and the signal processing component 54B do not lie on top of each other. By rotating the TFT substrate 30B 90 degrees with respect to the TFT substrate 30A in this way, the read-out direction of the electric charges in the TFT substrate 30A becomes the A direction, the read-out direction of the electric charges in the TFT substrate 30B becomes the B direction, and the read-out directions of the electric charges in the TFT substrates 30A and 30B intersect. The orientations of the subject images of the affected area in the radiographic images end up changing because of the difference in the reading directions from the radiation detectors 20A and 20B. For this reason, in the case of performing image processing that performs addition or weighted addition, per corresponding pixel, with respect to the sets of image information representing the radiographic images captured by the radiation detectors 20A and 20B, it suffices for the cassette control component 58 to perform, for example, image processing that rotates the radiographic images in accordance with the reading directions in such a way that the orientations of the subject images become a constant direction and thereafter perform image processing that performs addition or weighted addition.

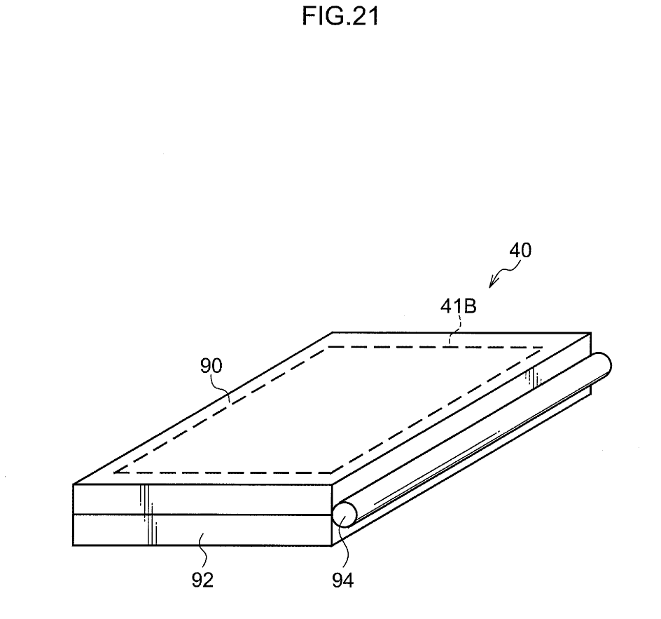

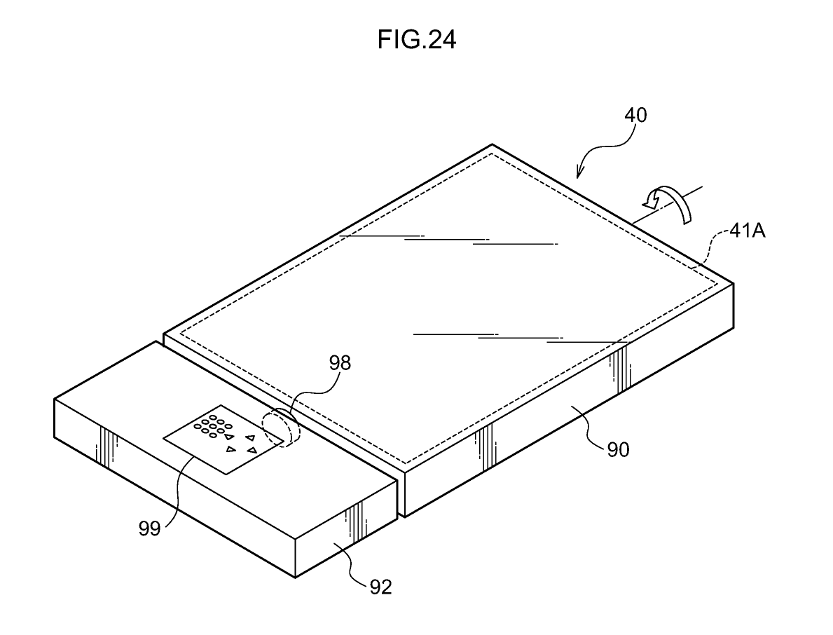

Further, in the above embodiment, the electronic cassette 40 can be entirely reversed so that imaging with both sides of the imaging region 41A and the imaging region 41B can be performed, but a configuration that makes it possible to open and close the electronic cassette 40, such as shown in FIG. 21 to FIG. 23, and a configuration that makes it possible to reverse part of the electronic cassette 40, such as shown in FIG. 24 to FIG. 26, can be exemplified.

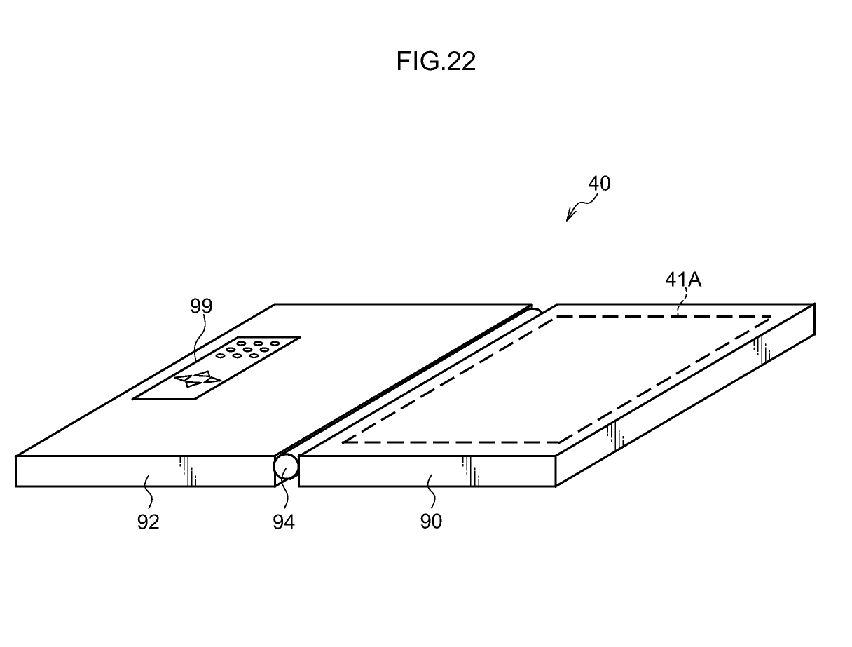

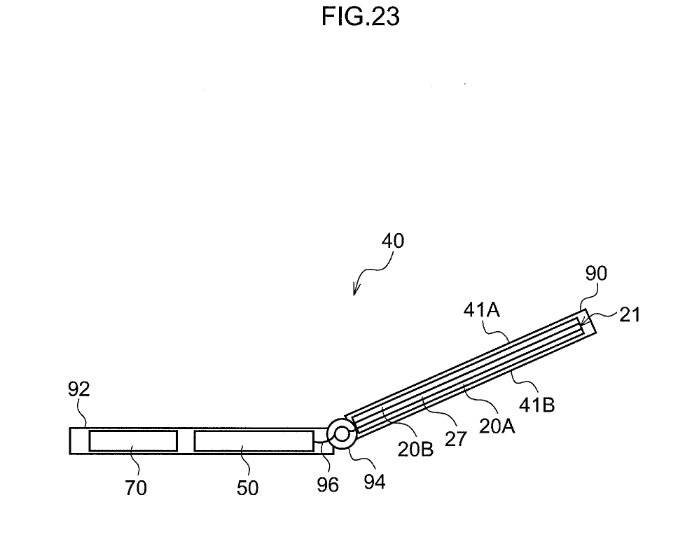

In FIG. 21 and FIG. 22, there are shown perspective views showing other another configuration of the electronic cassette 40, and in FIG. 23, there is shown a cross-sectional view showing the schematic configuration of the electronic cassette 40. Identical reference signs will be given to portions corresponding to those of the electronic cassette 40 of the above embodiment, and description of portions having the same functions will be omitted.

The imaging component 21, the gate line drivers 52A and 52B, and the signal processing components 54 and 54B are built into the electronic cassette 40. A flat plate-shaped imaging unit 90, which captures radiographic images resulting from applied radiation, and a control unit 92, into which the control component 50 and the power source component 70 are built, are coupled together by a hinge 94 in such a way that the imaging unit 90 and the control unit 92 can be opened and closed.

When one of the imaging unit 90 and the control unit 92 rotates about the hinge 94 with respect to the other, the imaging unit 90 and the control unit 92 can be opened to a deployed state in which the imaging unit 90 and the control unit 92 lie side by side (FIG. 22) and closed to a stored state in which the imaging unit 90 and the control unit 92 are folded on top of each other (FIG. 21).

The imaging component 21 is built into the imaging unit 90 in such a way that, as shown in FIG. 23, in the stored state the radiation detector 20B is on the control unit 92 side and the radiation detector 20A is on the outside (the opposite side of the control unit 92 side). The side of the imaging unit 90 that becomes the outside in the stored state is the imaging region 41B with the sensitivity emphasis, and the side of the imaging unit 90 that opposes the control unit 92 is the imaging region 41A with the image quality emphasis.

The imaging component 21 is connected to the control component 50 and the power source component 70 by a connection wire 96 disposed in the hinge 94.

In this way, the electronic cassette 40 is opened and closed and performs imaging with the imaging region 41A or the imaging region 41B, whereby the electronic cassette 40 can easily capture radiographic images with different characteristics.

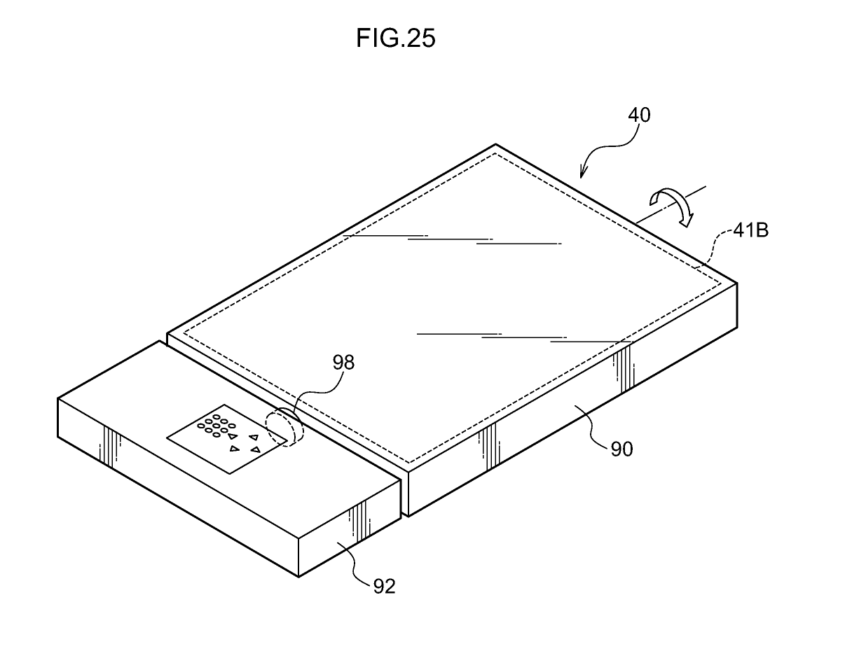

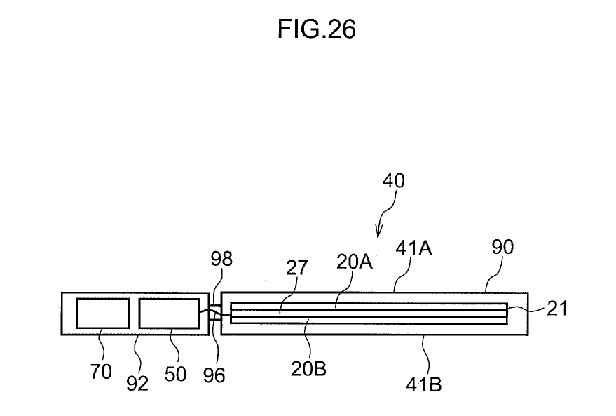

In FIG. 24 and FIG. 25, there are shown perspective views showing another configuration of the electronic cassette 40 pertaining to the embodiment, and in FIG. 26, there is shown a cross-sectional view showing the schematic configuration of the electronic cassette 40. Identical reference signs will be given to portions corresponding to those of the electronic cassette 40 of the second embodiment, and description of portions having the same functions will be omitted.

The imaging component 21, the gate line drivers 52A and 52B, and the signal processing components 54 and 54B are built into the electronic cassette 40. A flat plate-shaped imaging unit 90, which captures radiographic images resulting from applied radiation, and a control unit 92, into which the control component 50 and the power source component 70 are built, are coupled together by a rotating shaft 98 in such a way that the imaging unit 90 and the control unit 92 can be rotated.

Further, in the imaging unit 90, the imaging regions 41A and 41B are disposed on one side and the other side of the flat plate shape in correspondence to the disposed position of the imaging component 21.

The imaging component 21 is built into the imaging unit 90 in such a way that the radiation detector 20B is on the imaging region 41B side and the radiation detector 20A is on the imaging region 41A side. The imaging component 21 is configured in such a way that the imaging region 41B is the imaging region with the sensitivity emphasis and the imaging region 41A is the imaging region with the image quality emphasis.

The imaging component 21 is connected to the control component 50 and the power source component 70 by a connection wire 96 disposed in the rotating shaft 98.

When one of the imaging unit 90 and the control unit 92 rotates with respect to the other, the imaging unit 90 and the control unit 92 can be changed to a state in which the imaging region 41A and an operation panel 99 lie side by side (FIG. 24) and a state in which the imaging region 41B and the operation panel 99 lie side by side (FIG. 25).

In this way, the electronic cassette 40 is rotated and performs imaging with the imaging region 41A or the imaging region 41B, whereby the electronic cassette 40 can easily capture radiographic images with different characteristics.

The disclosure of Japanese Patent Application No. 2010-149856 is incorporated in its entirety by reference in the present specification.

All documents, patent applications, and technical standards described in the present specification are incorporated by reference in the present specification to the same extent as if each individual document, patent application, and technical standard were specifically and individually indicated to be incorporated by reference.

What is claimed is:

1. A radiographic imaging device comprising an imaging component that is disposed with plural sensor portions sensitive to light and has at least two imaging systems that capture radiographic images expressed by light generated in a light-emitting layer that generates light as a result of radiation being applied, with the imaging component being configured to be able to individually read out sets of image information representing the radiographic images captured by the imaging systems, and with the sensor portions configuring at least one of the imaging systems being configured to include an organic photoelectric conversion material that generates an electric charge by receiving light.

2. The radiographic imaging device according to claim 1, further comprising
a read-out component that individually reads out the sets of image information representing the radiographic images captured by the imaging systems and
an image processing component that performs image processing that performs addition or weighted addition of the sets of image information read out by the read-out component.

3. The radiographic imaging device according to claim 1, wherein the imaging component is configured in such a way that the light-emitting layer and two substrates, in which are formed the plural sensor portions and plural switch elements for reading out the electric charges generated in the sensor portions, are layered.

4. The radiographic imaging device according to claim 3, wherein the substrates are configured by any of plastic resin, aramids, bio-nanofibers, or flexible glass substrates.

5. The radiographic imaging device according to claim 3, wherein the switch elements are thin-film transistors configured to include an amorphous oxide in their active layers.

6. The radiographic imaging device according to claim 3, wherein the imaging component is configured such that two of the light-emitting layers are disposed, a light-blocking layer that blocks light is disposed, and the light-emitting layers and the substrates are layered on one side and the other side of the light-blocking layer.

7. The radiographic imaging device according to claim 6, wherein the two light-emitting layers have different light emission characteristics with respect to radiation.

8. The radiographic imaging device according to claim 7, wherein a change to any of at least one of a thickness of the light-emitting layers, a particle diameter of particles that fill the light-emitting layers and emit light as a result of radiation being applied, a multilayer structure of the particles, a fill rate of the particles, a doping amount of an activator, a material of the light-emitting layers, or the layer structure of the light-emitting layers or a formation of a reflective layer that reflects the light on the sides of the light-emitting layers not opposing the substrates is performed on the two light-emitting layers.

9. The radiographic imaging device according to claim 6, wherein one of the two light-emitting layers has a light emission characteristic with an image quality emphasis, and the other of the two light-emitting layers has a light emission characteristic with a sensitivity emphasis.

10. The radiographic imaging device according to claim 6, wherein the two light-emitting layers have substantially identical light emission characteristics with respect to radiation when radiation has been applied from one side.

11. The radiographic imaging device according to claim 3, wherein the two substrates have different read-out characteristics of reading out signals obtained by reading out the stored electric charges.

12. The radiographic imaging device according to claim 2, further comprising
an imaging unit that is formed in the shape of a flat plate, has the imaging component built into it, and can capture radiographic images resulting from applied radiation in both one side and the other side of the flat plate,
a control unit that has the read-out component and the image processing component built into it, and
a coupling member that couples together the imaging unit and the control unit in such a way that the imaging unit and the control unit can be opened to a deployed state in which the imaging unit and the control unit lie side by side and closed to a stored state in which the imaging unit and the control unit are folded on top of each other.

13. The radiographic imaging device according to claim 2, further comprising
an imaging unit that is formed in the shape of a flat plate, has the imaging component built into it, and can capture radiographic images resulting from applied radiation in both one side and the other side of the flat plate,
a control unit that has the read-out component and the image processing component built into it, and
a coupling member that couples together the imaging unit and the control unit in such a way that one side and the other side of the imaging unit can be reversed with respect to the control unit.
